(19) United States
(12) Patent Application Publication
(10) Pub. No.: US 2025/0150505 A1
(43) Pub. Date: May 8, 2025

(54) DATA PROCESSING METHOD AND APPARATUS

(71) Applicant: Tencent Technology (Shenzhen) Company Limited, Shenzhen (CN)

(72) Inventor: Zhuguang SHAO, Shenzhen (CN)

(73) Assignee: Tencent Technology (Shenzhen) Company Limited, Shenzhen (CN)

(21) Appl. No.: 19/016,700

(22) Filed: Jan. 10, 2025

Related U.S. Application Data
(63) Continuation of application No. PCT/CN2023/131714, filed on Nov. 15, 2023.

(30) Foreign Application Priority Data
Jan. 12, 2023 (CN) 2023100420257

(51) Int. Cl. H04L 67/1061

(52) U.S. Cl. CPC H04L 67/1065; H04L 67/1068

(57) ABSTRACT

This disclosure relates to a data processing method and apparatus, which may be applied to the field of blockchains to address low stability of a data processing process in a blockchain system. The method includes: obtaining status information of each of the slave nodes, the status information comprising a communication connection status of the corresponding slave node and a status of a blockchain recorded by the slave node in the blockchain system; in response to the status information of a first slave node among the slave nodes meeting a freeze condition, generating and broadcasting a node freeze proposal; and in response to the master node reaching a consensus on the node freeze proposal with the slave nodes based on a consensus algorithm, performing data interaction with the slave nodes other than the first slave node before the recorded blockchains reach the frozen block height.

### RELATED APPLICATION

This application is a continuation application of PCT Patent Application No. PCT/CN2023/131714, filed on Nov. 15, 2023, which claims priority to Chinese Patent Application No. 2023100420257, entitled “DATA PROCESSING METHOD AND APPARATUS, DEVICE, AND STORAGE MEDIUM” filed with the China National Intellectual Property Administration on Jan. 12, 2023, wherein the content of the above-referenced applications is incorporated herein by reference in its entirety.

### FIELD OF THE TECHNOLOGY

This application relates to the field of computer technologies, and in particular, to a data processing method and apparatus, a device, and a storage medium.

### BACKGROUND OF THE DISCLOSURE

With the continuous development of science and technology, more and more devices store data by using a blockchain technology. In a blockchain system formed by a plurality of devices, the devices are equivalent to nodes in the blockchain system, and blockchains are respectively recorded by the nodes. Therefore, only when the nodes reach a consensus, data processing can be performed on the blockchains recorded by the nodes, so that data stored in the blockchains is more realistic and reliable.

In the related art, a data processing method in the blockchain system generally includes the following operations: First, one node is selected as a master node from the nodes, and other nodes are used as slave nodes. Then, the master node selects a specified quantity of transactions from a transaction pool, to generate a transaction proposal. Finally, when the master node reaches a consensus on the transaction proposal with the slave nodes, the master node and the slave nodes add blocks formed by the transactions indicated by the transaction proposal to the blockchains respectively recorded by the master node and the slave nodes, to complete the transactions.

However, when one node is selected as the master node from the nodes, each of the nodes rotates the master node according to a specific rule. Therefore, if a node is offline or has a block height lag and the node exactly needs to become the master node according to the rule, after the node becomes the master node, the node can only select the specified quantity of transactions from the transaction pool to generate the transaction proposal. However, because the transaction proposal cannot be broadcast to the slave nodes, the master node cannot perform a consensus process on the transaction proposal with the slave nodes. In this case, the current data processing process is stuck, and the stuck situation does not end until a timeout occurs and a next master node is rotated. Further, in a subsequent master node rotation process, each time the master node is rotated, the corresponding data processing process may be stuck, seriously affecting overall data processing progress of a service scenario. This is unacceptable for a service scenario with a high performance requirement.

In view of this, in the related art, stability of the data processing process in the blockchain system is low.

### SUMMARY

An embodiment of this disclosure provides a data processing method, applied to a master node in a plurality of nodes included in a blockchain system. The plurality of nodes further include a plurality of slave nodes associated with the master node. The data processing method includes:
obtaining status information of each of the slave nodes, the status information comprising a communication connection status of the corresponding slave node and a status of a blockchain recorded by the slave node in the blockchain system;
in response to the status information of a first slave node among the slave nodes meeting a freeze condition, generating and broadcasting a node freeze proposal, the node freeze proposal being for representing a node freeze transaction of the first slave node, and the node freeze transaction indicating to restrict data interaction of the first slave node with other nodes before blockchains recorded by the other nodes reach a frozen block height; and
in response to the master node reaching a consensus on the node freeze proposal with the slave nodes based on a consensus algorithm, performing data interaction with the slave nodes other than the first slave node before the recorded blockchains reach the frozen block height.

An embodiment of this disclosure provides a data processing method, applied to slave nodes in a plurality of nodes included in a blockchain system. The plurality of nodes further include a master node associated with the slave nodes. The data processing method includes:
receiving a node freeze proposal broadcast by the master node, the node freeze proposal being generated when the master node determines that a first slave node whose status information meets a freeze condition exists in the slave nodes, the node freeze proposal being for representing a node freeze transaction of the first slave node, and the node freeze transaction being indicating to restrict data interaction with the first slave node before blockchains recorded by other slave nodes reach a frozen block height; and
in response to a consensus being reached on the node freeze proposal among the master node and the slave nodes based on a consensus algorithm, performing data interaction with the master node and the slave nodes other than the first slave node before the recorded blockchains reach the frozen block height.

An embodiment of this disclosure provides a data processing apparatus, applied to a master node in a plurality of nodes included in a blockchain system. The plurality of nodes further include a plurality of slave nodes associated with the master node. The data processing apparatus includes a memory operable to store computer-readable instructions and a processor circuitry operable to read the computer-readable instructions. When executing the computer-readable instructions, the processor circuitry is configured to:
obtain status information of each of the slave nodes, the status information comprising a communication connection status of the corresponding slave node and a status of a blockchain recorded by the slave node in the blockchain system;
in response to the status information of a first slave node among the slave nodes meeting a freeze condition, generate and broadcast a node freeze proposal, the node freeze proposal being for representing a node freeze transaction of the first slave node, and the node freeze transaction indicating to restrict data interaction of the first slave node with other nodes before blockchains recorded by the other nodes reach a frozen block height; and
in response to the master node reaching a consensus on the node freeze proposal with the slave nodes based on a consensus algorithm, perform data interaction with the slave nodes other than the first slave node before the recorded blockchains reach the frozen block height.

An embodiment of this disclosure provides a computer program product, including a computer program, the computer program, when executed by a processor, implementing the method according to the embodiments of this disclosure.

An embodiment of this disclosure provides a computer device, including:
a memory, configured to store program instructions; and
a processor, configured to invoke the program instructions stored in the memory, to perform the method according to the embodiments of this disclosure according to the obtained program instructions.

An embodiment of this disclosure provides a computer-readable storage medium, having computer-executable instructions stored therein, the computer-executable instructions being configured for causing a computer to perform the method according to the embodiments of this disclosure.

### BRIEF DESCRIPTION OF THE DRAWINGS

related art.

FIG. 1A is a schematic principle diagram of a data processing method in the

FIG. 1B shows an application scenario of a data processing method according to an embodiment of this disclosure.

FIG. 2 is a schematic flowchart 1 of a data processing method according to an embodiment of this disclosure.

FIG. 3A is a schematic principle diagram 1 of a data processing method according to an embodiment of this disclosure.

FIG. 3B is a schematic principle diagram 2 of a data processing method according to an embodiment of this disclosure.

FIG. 3C is a schematic principle diagram 3 of a data processing method according to an embodiment of this disclosure.

FIG. 4 is a schematic flowchart 2 of a data processing method according to an embodiment of this disclosure.

FIG. 5A is a schematic flowchart 3 of a data processing method according to an embodiment of this disclosure.

FIG. 5B is a schematic principle diagram 4 of a data processing method according to an embodiment of this disclosure.

FIG. 6 is a schematic flowchart 4 of a data processing method according to an embodiment of this disclosure.

FIG. 7A is a schematic flowchart 5 of a data processing method according to an embodiment of this disclosure.

FIG. 7B is a schematic flowchart 6 of a data processing method according to an embodiment of this disclosure.

FIG. 7C is a schematic flowchart 7 of a data processing method according to an embodiment of this disclosure.

FIG. 7D is a schematic principle diagram 5 of a data processing method according to an embodiment of this disclosure.

FIG. 7E is a schematic principle diagram 6 of a data processing method according to an embodiment of this disclosure.

FIG. 8A is a schematic structural diagram 1 of a data processing apparatus according to an embodiment of this disclosure.

FIG. 8B is a schematic structural diagram 2 of a data processing apparatus according to an embodiment of this disclosure.

FIG. 9 is a schematic structural diagram 3 of a data processing apparatus according to an embodiment of this disclosure.

### DESCRIPTION OF EMBODIMENTS

To make the objectives, technical solutions, and advantages of the embodiments of this disclosure clearer, the following clearly and completely describes the technical solutions in the embodiments of this disclosure with reference to the accompanying drawings in the embodiments of this disclosure.

Some terms in the embodiments of this disclosure are first explained below, to facilitate understanding of a person skilled in the art.

### Blockchain

The blockchain is a chain formed by a plurality of blocks. Each block stores specific information. The blocks are connected to form the chain based on a time sequence in which the blocks are generated. The chain is stored in all servers. The entire blockchain is secure as long as one server in an entire blockchain system can work. The servers are referred to as nodes in the blockchain system, and provide storage space and computing power support for the entire blockchain system.

The embodiments of this disclosure relate to the field of blockchains, which may be applied to fields such as smart transportation, smart agriculture, smart medicine, or maps.

The blockchain is a new application mode of computer technologies such as distributed data storage, peer-to-peer transmission, a consensus mechanism, and an encryption algorithm. The blockchain is essentially a decentralized database and is a string of data blocks generated through association by using a cryptographic method. Each data block includes information about a batch of network transactions, to perform verification on validity of the information of the data block (anti-counterfeiting) and generate a next data block. The blockchain may include an underlying blockchain platform, a platform product service layer, and an application service layer.

The underlying blockchain platform may include processing modules, for example, a user management module, a basic service module, and a smart contract module. The user management module is responsible for identity information management of all blockchain participants, including maintenance of public and private key generation (account management), key management, maintenance of a correspondence between a real identity of a user and a blockchain address (permission management), and the like; and supervising and auditing transaction situations of some real identities in a case of authorization, and providing rule configuration for risk control (risk control audit). The basic service module is deployed on all blockchain node devices, and is configured to perform verification on validity of a service request, and record and store a valid request in a storage after completing a consensus on the valid request. For a new service request, the basic service module first adapts parsing and authentication processing to an interface (interface adaptation), then encrypts service information based on a consensus algorithm (consensus management), then completely and consistently transmits the service information to a shared ledger after the encryption (network communication), and records and stores the service information. The smart contract module is responsible for contract registration, contract issuance, contract triggering, and contract execution. A developer may define contract logic by using a programming language, and release the contract logic onto a blockchain (contract registration). According to the logic of contract items, a key or another event is invoked to trigger execution, to complete the contract logic. Functions of smart contract upgrade and cancellation are further provided.

Here, the term “module” (and other similar terms such as unit, submodule, etc.) refers to computing software, firmware, hardware, and/or various combinations thereof. At a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry on the same or different integrated circuit.

The platform product service layer provides basic capabilities and an implementation framework of a typical application. Based on these basic capabilities, developers may superpose characteristics of services and complete blockchain implementation of service logic. The application service layer provides an application service based on a blockchain solution to service participants for use.

Data related to status information and the like is involved in the embodiments of this disclosure. When the foregoing embodiments of this disclosure are applied to a specific product or technology, the user's permission or consent needs to be obtained, and collection, use, and processing of the relevant data need to comply with relevant laws, regulations, and standards of relevant countries and regions.

An application field of a data processing method provided in the embodiments of this disclosure is described below.

With the continuous development of science and technology, more and more devices store data by using a blockchain technology. In a blockchain system formed by a plurality of devices, the devices are equivalent to nodes in the blockchain system, and blockchains are respectively recorded by the nodes. Therefore, only when the nodes reach a consensus, data processing can be performed on the blockchains recorded by the nodes, so that data stored in the blockchains is more realistic and reliable.

In the related art, a data processing method in the blockchain system generally includes the following operations: First, one node is selected as a master node from the nodes, and other nodes are used as slave nodes. Then, the master node selects a specified quantity of transactions from a transaction pool, to generate a transaction proposal. Finally, when the master node reaches a consensus on the transaction proposal with the slave nodes, the master node and the slave nodes add blocks formed by the transactions indicated by the transaction proposal to the blockchains respectively recorded by the master node and the slave nodes, to complete the transactions.

However, when one node is selected as the master node from the nodes, each of the nodes rotates the master node according to a specific rule. Therefore, if a node is offline or has a block height lag and the node exactly needs to become the master node according to the rule, after the node becomes the master node, the node can only select the specified quantity of transactions from the transaction pool to generate the transaction proposal. However, because the transaction proposal cannot be broadcast to the slave nodes, the master node cannot perform a consensus process on the transaction proposal with the slave nodes. In this case, the current data processing process is stuck, and the stuck situation does not end until a timeout occurs and a next master node is rotated. Further, in a subsequent master node rotation process, each time the master node is rotated, the corresponding data processing process may be stuck, seriously affecting overall data processing progress of a service scenario. This is unacceptable for a service scenario with a high performance requirement.

For example, a data processing method based on a consensus algorithm (Tendermint BFT, TBFT) includes the following operations: First, one node is selected as a master node from nodes, and other nodes are used as slave nodes. Three stages of a consensus process are entered, and include a proposal stage, a feedback stage, and a commit stage.

In the proposal stage, the master node selects a specified quantity of transactions from a transaction pool, to generate and broadcast a transaction proposal; and the slave nodes perform verification on the transaction proposal, and generate and broadcast feedback information. In the feedback stage, the master node and the slave nodes generate and broadcast commit information according to the received feedback information. In the commit stage, when it is determined that the master node reaches a consensus on the transaction proposal with the slave nodes according to the received commit information, the master node and the slave nodes add blocks formed by the transactions indicated by the transaction proposal to blockchains respectively recorded by the master node and the slave nodes, to complete the transactions. When it is determined that the consensus is not reached on the transaction proposal, the master node and the slave nodes enter a next round of consensus process.

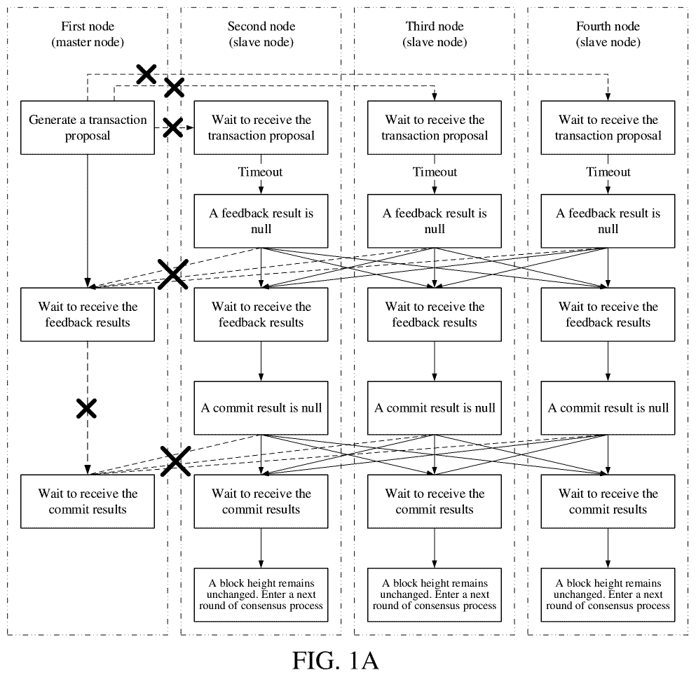

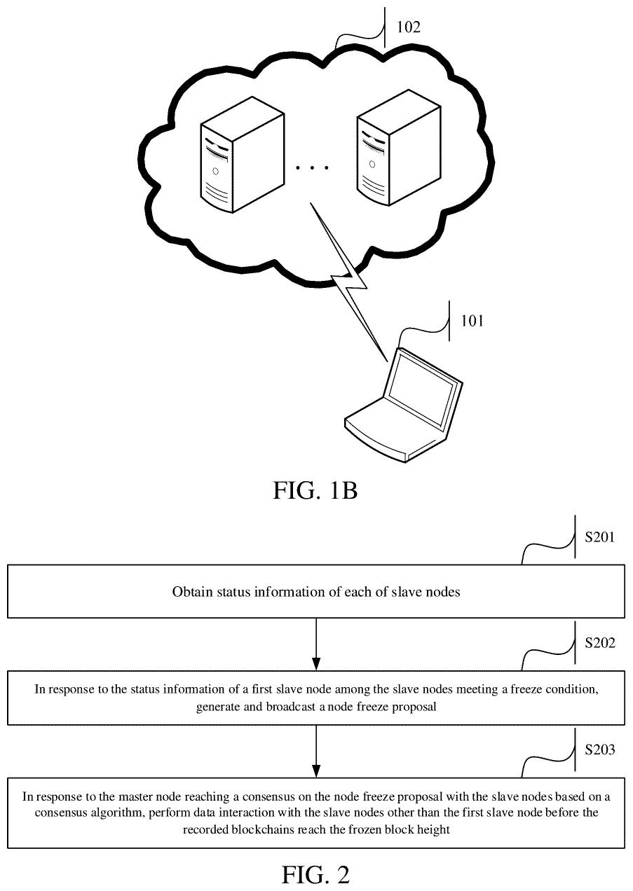

Referring to FIG. 1A, a blockchain system includes four nodes, that is, a first node, a second node, a third node, and a fourth node. The nodes determine whether the nodes need to generate a proposal. If one node is selected as a master node from the nodes according to a specific rotation rule such as a direct loop rule, for example, the first node is used as a master node, the master node determines that a proposal needs to be generated. Other nodes (the second node, the third node, and the fourth node) are used as slave nodes and wait to receive the proposal.

After the master node and the slave nodes are determined, a proposal stage is entered. The master node selects a specified quantity of transactions from a transaction pool, to generate a transaction proposal. The master node broadcasts the transaction proposal to the second node, the third node, and the fourth node, and the slave nodes wait to receive the transaction proposal. However, because the master node is temporarily offline, has a block height lag, or the like, the master node cannot broadcast the transaction proposal to the second node, the third node, and the fourth node, and the slave nodes cannot receive the transaction proposal broadcast by the master node.

Because the second node, the third node, and the fourth node do not receive the transaction proposal until a timeout, when corresponding feedback results are generated, the feedback results are null. The second node, the third node, and the fourth node each broadcast the generated feedback result.

After the second node, the third node, and the fourth node each broadcast the generated feedback result, a feedback stage is entered. The master node waits to receive the feedback results broadcast by the slave nodes. However, because the master node is temporarily offline, has a block height lag, or the like, the master node cannot receive the feedback results broadcast by the slave nodes, cannot enter a process of receiving a commit result, and then cannot enter a commit stage.

The second node, the third node, and the fourth node each wait to receive feedback results broadcast by other slave nodes. The second node, the third node, and the fourth node each generate and broadcast a corresponding commit result according to null feedback results broadcast by the other slave nodes, where the commit result is still null.

After the second node, the third node, and the fourth node each broadcast the generated commit result, a commit stage is entered. The second node, the third node, and the fourth node each wait to receive commit results broadcast by the other slave nodes, and the second node, the third node, and the fourth node each determine, according to null commit results broadcast by the other slave nodes, that the master node does not reach a consensus with the slave nodes, so that block heights of blockchains respectively recorded by the second node, the third node, and the fourth node remain unchanged, and a next round of consensus process is entered.

It can be learned from the foregoing process that, when a node is temporarily offline, has a block height lag, or the like, the node still rotates a master node according to a rule. If timeout duration of one round of consensus process is set to 30 seconds, the master node causes the data processing process to be stuck for 30 seconds in a current round of consensus process, and the data processing process can resume normal only when a next node rotates a master node. For example, the four nodes are included in FIG. 1A. If the first node is a node that is temporarily offline or has a block height lag, each time the second node, the third node, and the fourth node each add a block to a blockchain, the data processing process is stuck for 30 seconds. In this way, the data processing process is frequently stuck, seriously affecting overall data processing progress of a service scenario. This is unacceptable for a service scenario with a high performance requirement.

In view of this, in the related art, stability of the data processing process in the blockchain system is low.

To address the problem of the low stability of the data processing process in the blockchain system, this application provides a data processing method. In the method, a blockchain system includes a plurality of nodes. The method is applied to a master node in the plurality of nodes. The method is applicable no matter which node in the plurality of nodes rotates a master node. The plurality of nodes further include a plurality of slave nodes associated with the master node.

In the method, status information of each of the slave nodes is obtained, the status information including a communication connection status of the corresponding slave node and a status of a blockchain of the blockchain system recorded by the slave node. A node freeze proposal is generated and broadcast when it is determined that a to-be-frozen node whose status information meets a freeze condition exists in the slave nodes, the node freeze proposal being configured for representing a node freeze transaction of the to-be-frozen node; and the node freeze transaction being configured for indicating to restrict data interaction with the to-be-frozen node before a blockchain of the blockchain system recorded by the corresponding slave node reaches a frozen block height. Based on a consensus algorithm in response to that the master node reaches a consensus on the node freeze proposal with the slave nodes, data interaction with the slave nodes except the to-be-frozen node is performed before the recorded blockchain of the blockchain system reaches the frozen block height.

In the embodiments of this disclosure, after a node in a blockchain system becomes a master node, it may be determined, according to status information of each of slave nodes, whether a to-be-frozen node whose status information meets a freeze condition exists in the slave nodes. When it is determined that the to-be-frozen node exists in the slave nodes, a node freeze proposal is generated and broadcast, to indicate to restrict data interaction with the to-be-frozen node before a blockchain of the blockchain system recorded by the corresponding slave node reaches a frozen block height. In this way, when the master node reaches a consensus on the node freeze proposal with the slave nodes, the master node performs data interaction with the slave nodes except the to-be-frozen node before the recorded blockchain of the blockchain system reaches the frozen block height.

In this way, in a plurality of nodes included in the blockchain system, if a node that is temporarily offline or has a block height lag exists, the current master node may determine the node as a to-be-frozen node in time, and freeze the to-be-frozen node for a period of time to cause the to-be-frozen node not to participate in data interaction, so that a data processing process of nodes that perform data interaction in the blockchain system is not stuck or even frequently stuck due to the node that is temporarily offline or has the block height lag, thereby avoiding affecting overall data processing progress of a service scenario, and improving stability of data processing.

An application scenario of the data processing method provided in the embodiments of this disclosure is described below.

FIG. 1B is a schematic diagram of an application scenario of a data processing method according to an embodiment of this disclosure. The application scenario includes a client 101 and a server side 102. The client 101 may communicate with the server side 102. The communication manner may be communication by using a wired communication technology, for example, communication by connecting to a network cable or a serial cable; or may be communication by using a wireless communication technology, for example, communication by using a technology such as Bluetooth or wireless fidelity (WiFi). This is not specifically limited.

The client 101 is generally a device that can provide a service requirement to the server side 102, to cause the server side 102 to generate a corresponding transaction, for example, a terminal device, a third-party application accessible to the terminal device, or a web page accessible to the terminal device. The terminal device may include, but not limited to, a phone, a computer, a smart medical care device, a smart home appliance, an in-vehicle terminal, an aircraft, or the like. The server side 102 is generally a device that can perform data processing, for example, a terminal device or a server. The server includes, but not limited to, a cloud server, a local server, a related third-party server, or the like. Both the client 101 and the server side 102 may use cloud computing to reduce occupation on local computing resources; and similarly, may also use cloud storage to reduce occupation on local storage resources.

In an embodiment, the client 101 and the server side 102 may be a same device, which are not specifically limited. In the embodiments of this disclosure, an example in which the client 101 and the server side 102 are different devices is used for description.

The data processing method provided in the embodiments of this disclosure is described below in detail based on FIG. 1B by using a master node in a blockchain system as an execution body. FIG. 2 is a schematic flowchart of a data processing method according to an embodiment of this disclosure.

S201: Obtain status information of each of slave nodes.

After a node in the blockchain system rotates a master node according to a specific rule, before selecting a transaction from a transaction pool to generate a proposal, the master node may first determine whether each of the slave nodes is abnormal. If an abnormal slave node that is temporarily offline or has a block height lag exists in the slave nodes, the abnormal slave node may be frozen for a period of time, so that a data processing process is not stuck when the abnormal slave node rotates a master node, thereby avoiding an unstable data processing process. Details are described below.

The master node may obtain the status information of the corresponding slave node from the slave nodes. The master node may store status information of the master node locally, or the master node may obtain the status information of the master node from another device. This is not specifically limited. The status information of the slave node may include a communication connection status of the corresponding slave node and a status of a blockchain of the blockchain system recorded by the slave node. The status information of the master node may include a status of a blockchain of the blockchain system recorded by the master node.

The communication connection status of the slave node may include a historical communication moment, where the historical communication moment is a moment with a smallest time difference from a current moment in moments at which the corresponding slave node communicates with the master node. In other words, the historical communication moment is a moment at which the corresponding slave node most recently communicates with the master node, for example, a moment at which the corresponding slave node most recently communicates with the master node by broadcasting a heartbeat signal.

The status of the blockchain of the blockchain system recorded by the slave node may include a slave node block height, where the slave node block height is a block height of the blockchain of the blockchain system recorded by the corresponding slave node. The status of the blockchain of the blockchain system recorded by the master node may include a master node block height, where the master node block height is a block height of the blockchain of the blockchain system recorded by the master node, and the block height is a quantity of blocks linked to the blockchain.

The status information may further include a current round of a consensus process performed by the nodes in the blockchain system that is recorded by the master node or the slave node, so that it can be determined whether the rounds recorded by the master node and the slave node are consistent, and the like. The status information may further include a current stage of the consensus process performed by the nodes in the blockchain system that is recorded by the master node or the slave node, where the current stage may be a proposal stage, a feedback stage, a commit stage, or the like, so that it can be determined whether the stages recorded by the master node and the slave node are consistent, or the like. This is not specifically limited.

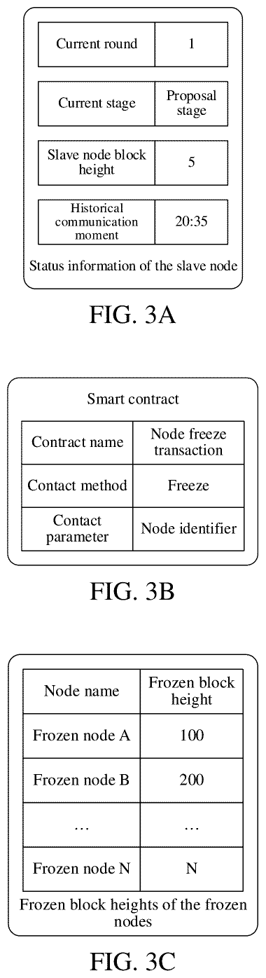

FIG. 3A shows status information of a slave node obtained by the master node, which includes a current round, a current stage, a slave node block height, and a historical communication moment. The current round is, for example, 1, the current stage is, for example, the proposal stage, the slave node block height is, for example, 5, and the historical communication moment is, for example, 20:35.

S202: Generate and broadcast a node freeze proposal when it is determined that a to-be-frozen node whose status information meets a freeze condition exists in the slave nodes.

After obtaining the status information of each of the slave nodes, the master node may determine, based on the communication connection status and the status of the blockchain included in the status information, whether the to-be-frozen node meeting the freeze condition exists in the slave nodes. If no to-be-frozen node meeting the freeze condition exists, it indicates that each of the slave nodes may perform normal communication, and the block height recorded by each of the slave nodes matches the block height recorded by the master node. In this case, according to a conventional data processing method, the master node may obtain a specified quantity of transactions from the transaction pool, generate a transaction proposal, and perform a subsequent data interaction and processing process based on the transaction proposal.

If a slave node meeting the freeze condition exists, it is determined that the corresponding slave node is the to-be-frozen node, which indicates that the to-be-frozen node cannot perform normal communication or a block height recorded by the to-be-frozen node does not match the block height recorded by the master node. In this case, the master node may generate the node freeze proposal and broadcast the node freeze proposal. The to-be-frozen node is frozen for a period of time, so that the data processing process is not stuck when the to-be-frozen node becomes a master node, thereby improving stability of the data processing process.

The node freeze proposal is configured for representing a node freeze transaction of the to-be-frozen node. The node freeze transaction is configured for indicating to restrict data interaction with the to-be-frozen node before a blockchain of the blockchain system recorded by the corresponding slave node reaches a frozen block height. In a form of the transaction, the to-be-frozen node may be removed for a period of time when the master node reaches a consensus with the slave nodes, so that the master node does not misjudge the to-be-frozen node. In addition, it can be ensured that status information of other nodes recorded by each node included in the blockchain system is consistent, that is, consistency of lists of nodes participating in the data processing process recorded by each node included in the blockchain system is ensured, thereby avoiding an abnormality in the data processing process.

In an embodiment, it is assumed that the communication connection status includes a historical communication moment, where the historical communication moment is a moment with a smallest time difference from a current moment in moments at which the corresponding slave node communicates with the master node; and the status of the blockchain includes a slave node block height, where the slave node block height is a block height of the blockchain of the blockchain system recorded by the corresponding slave node. In this case, the freeze condition may be that a time difference between the historical communication moment and the current moment is greater than a preset duration threshold, which indicates that long time has passed since a message from a slave node was received last time; or may be that a height difference between the slave node block height and the master node block height is greater than a preset height difference threshold, which indicates that a block height recorded by a slave node is much lower than the block height recorded by the master node; or may be that the time difference between the historical communication moment and the current moment is greater than the preset duration threshold and the height difference between the slave node block height and the master node block height is greater than the preset height difference threshold; or the like. This is not specifically limited. The master node block height is the block height of the blockchain of the blockchain system recorded by the master node; and

For example, the master node uses, as the to-be-frozen node from the slave nodes, a slave node in which a time difference between a historical communication moment and the current moment is greater than the preset duration threshold and a height difference between a slave node block height and the master node block height is greater than the preset height difference threshold. In this way, the master node may create the node freeze transaction for the to-be-frozen node, and generate and broadcast the node freeze proposal based on the node freeze transaction.

The node freeze transaction may be in a form of a smart contract. FIG. 3B shows a smart contract for a node freeze transaction, which includes a contract name, a contract method, and a contract parameter. The contract name is configured for uniquely representing the node freeze transaction, the contract method is configured for representing that the node freeze transaction indicates to freeze a node, and the contract parameter is configured for representing a node identifier of the to-be-frozen node indicated by the node freeze transaction, such as a node code, which are not specifically limited.

The master node may broadcast the node freeze proposal to the slave nodes except the to-be-frozen node or the slave nodes including the to-be-frozen node. When the master node broadcasts the node freeze proposal to the slave nodes including the to-be-frozen node, if the to-be-frozen node has been offline, the master node cannot broadcast the node freeze proposal to the to-be-frozen node, which is actually equivalent to that the to-be-frozen node does not participate in a consensus process for the node freeze proposal; if the block height recorded by the to-be-frozen node lags behind, the to-be-frozen node does not execute the previous to-be-frozen proposal, which is actually equivalent to that the to-be-frozen node does not participate in the consensus process for the node freeze proposal; or if the to-be-frozen node is normal, the to-be-frozen node participates in the consensus process for the node freeze proposal.

In an embodiment, after a node in the blockchain system rotates a master node according to a specific rule, before selecting a transaction from a transaction pool to generate a proposal, the master node may also first determine whether a to-be-unfrozen node that may be unfrozen exists in the slave nodes. For example, if a node is frozen through a node freeze transaction and does not participate in the data processing process before the frozen block height is reached, when blockchains recorded by other nodes reach the frozen block height (that is, when block heights match), the to-be-unfrozen node may be unfrozen, so that the node can participate in the subsequent data processing process.

If each of the slave nodes is associated with a freeze status and the freeze status is frozen or unfrozen, after obtaining the status information of each of the slave nodes, the master node may determine whether a to-be-unfrozen node whose freeze status is frozen and whose status information meets an unfreeze condition exists in the slave nodes.

If it is determined that no to-be-unfrozen node whose freeze status is frozen and whose status information meets the unfreeze condition exists in the slave nodes, the master node obtains a specified quantity of transactions from the transaction pool, generates a transaction proposal, and continues the subsequent data processing process.

If it is determined that the to-be-unfrozen node whose freeze status is frozen and whose status information meets the unfreeze condition exists in the slave nodes, a node unfreeze proposal is generated and broadcast. The node unfreeze proposal is configured for representing a node unfreeze transaction of the to-be-unfrozen node. The node unfreeze transaction is configured for indicating that the to-be-unfrozen node participates in data interaction when a blockchain of the blockchain system recorded by the corresponding slave node reaches an unfrozen block height. The unfrozen block height may be a frozen block height indicated when the to-be-unfrozen node is frozen through the node freeze transaction; or the unfrozen block height may be different from the corresponding frozen block height. This is not specifically limited.

After the master node broadcasts the node unfreeze proposal, when it is determined that the master node reaches a consensus on the node unfreeze proposal with the slave nodes except the to-be-unfrozen node, the master node may perform, based on a consensus algorithm, data interaction with the slave nodes including the to-be-unfrozen node when the recorded blockchain of the blockchain system reaches the unfrozen block height, for example, perform the data processing process based on the transaction pool. In this way, a process of unfreezing the to-be-unfrozen node is completed, so that the to-be-unfrozen node participates in the data processing process. A consensus process for the node unfreeze proposal is similar to the consensus process for the node freeze proposal described below.

The freeze status of the slave node may be associated in a form of a tag, or may be obtained based on frozen block heights of frozen nodes stored in a contract in a ledger of the blockchain system, or the like. This is not specifically limited. FIG. 3C shows frozen block heights of frozen nodes recorded in a ledger. A frozen block height of a frozen node A indicated by a node freeze transaction A is 100; a frozen block height of a frozen node B indicated by a node freeze transaction B is 200; a frozen block height of a frozen node N indicated by a node freeze transaction N is N; and the like.

In this case, the master node may obtain the frozen block heights of the frozen nodes, and determine whether the block height of the blockchain recorded by the master node is equal to the frozen block heights of the frozen nodes. If the block height of the blockchain recorded by the master node is less than a frozen block height of a frozen node, it indicates that the frozen block height of the frozen node is not reached. In this case, a freeze status of the frozen node is frozen. If the block height of the blockchain recorded by the master node is greater than a frozen block height of a frozen node, it indicates that the frozen block height of the frozen node is exceeded. In this case, a freeze status of the frozen node is unfrozen. If the block height of the blockchain recorded by the master node is equal to a frozen block height of a frozen node, it indicates that the frozen block height of the frozen node is exactly reached and the frozen node may be unfrozen. In this case, a freeze status of the frozen node is frozen.

S203: Perform, based on a consensus algorithm in response to that the master node reaches a consensus on the node freeze proposal with the slave nodes, data interaction with the slave nodes except the to-be-frozen node before the recorded blockchain of the blockchain system reaches the frozen block height.

After the master node broadcasts the node freeze proposal, the master node may determine, based on the consensus algorithm, whether the master node reaches the consensus on the node freeze proposal with the slave nodes. If the master node reaches the consensus on the node freeze proposal with the slave nodes, a node frozen block formed by the node freeze transaction may be added to the blockchain of the blockchain system recorded by the master node, and the block height of the blockchain recorded by the master node also increases; and the master node performs data interaction with the slave nodes except the to-be-frozen node before the blockchain of the blockchain system recorded by the master node reaches the frozen block height, for example, performs the data processing process based on the transaction pool. The data processing process based on the transaction pool may be continued by the current master node, or may be performed by a next node rotating a master node, or the like. This is not specifically limited. If the master node does not reach the consensus on the node freeze proposal with the slave nodes, the master node may give up the current round of consensus, and a next node rotates a master node to enter a next round of consensus process, or the like. This is not specifically limited.

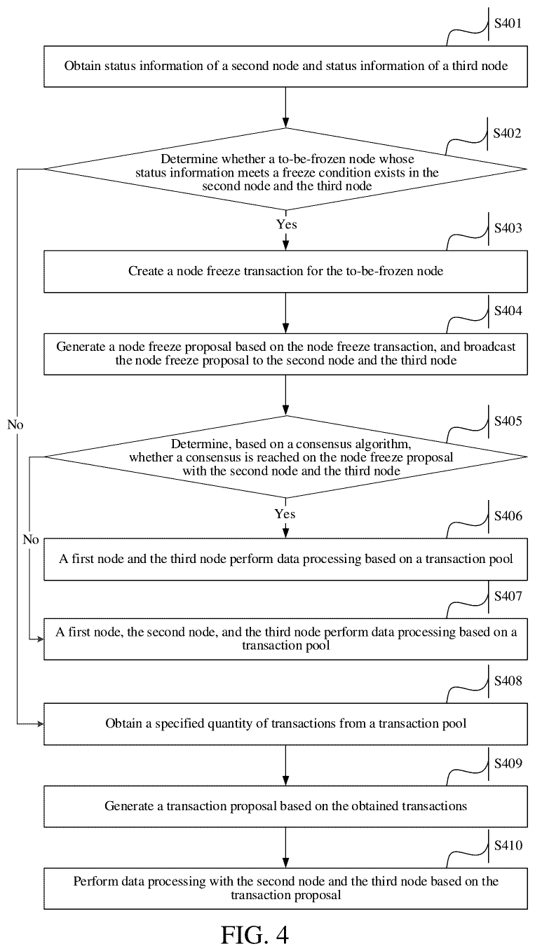

For example, the blockchain system includes three nodes, that is, a first node, a second node, and a third node. The first node rotates a master node in a current round, and the second node and the third node are slave nodes. In this case, referring to FIG. 4, a process in which the first node, the second node, and the third node perform data processing may be as follows:

S401: The first node obtains status information of the second node and status information of the third node.

In some embodiments of this disclosure, the status information of the second node includes a communication connection status of the second node, where the communication connection status is a historical communication moment A; and further includes a status of a blockchain of the blockchain system recorded by the second node, where the status of the blockchain is a slave node block height A. The status information of the third node includes a communication connection status of the third node, where the communication connection status is a historical communication moment B; and further includes a status of a blockchain of the blockchain system recorded by the third node, and the status of the blockchain is a slave node block height B.

S402: The first node determines whether a to-be-frozen node whose status information meets a freeze condition exists in the second node and the third node.

In some embodiments, the freeze condition may be that a time difference between a historical communication moment and a current moment is greater than a preset duration threshold, which indicates that long time has passed since a message from a slave node was received last time; or may be that a height difference between a slave node block height and a master node block height is greater than a preset height difference threshold, which indicates that a block height recorded by a slave node is much lower than the block height recorded by the master node; or may be that the time difference between the historical communication moment and the current moment is greater than the preset duration threshold and the height difference between the slave node block height and the master node block height is greater than the preset height difference threshold; or the like. Therefore, according to the historical communication moment and the slave node block height, the to-be-frozen node meeting the freeze condition is determined from the slave nodes, the time difference between the historical communication moment of the determined to-be-frozen node and the current moment being greater than the preset duration threshold, and the height difference between the slave node block height of the determined to-be-frozen node and the master node block height being greater than the preset height difference threshold. For example, the first node may determine, according to the freeze condition, whether a time difference between each of the historical communication moment A and the historical communication moment B and the current moment is greater than the preset duration threshold; and determine whether a height difference between each of the slave node block height A and the slave node block height B and the master node block height is greater than the preset height difference threshold. If the time difference between the historical communication moment A and the current moment is greater than the preset duration threshold, and the height difference between the slave node block height A and the master node block height is greater than the preset height difference threshold, it is determined that the second node is the to-be-frozen node.

S403: When it is determined that the to-be-frozen node exists, the first node creates a node freeze transaction for the to-be-frozen node.

For example, if the first node determines that the second node is the to-be-frozen node, the first node may determine a frozen block height of the second node according to a preset freeze policy. The frozen block height represents that the first node and the third node perform data interaction before blockchains respectively recorded by the first node and the third node reach the frozen block height, and the second node does not participate in the data processing process.

S404: The first node generates a node freeze proposal based on the node freeze transaction, and broadcasts the node freeze proposal to the second node and the third node.

S405: The first node determines, based on a consensus algorithm, whether the first node reaches a consensus on the node freeze proposal with the second node and the third node.

S406: When the first node determines that the first node reaches the consensus on the node freeze proposal with the second node and the third node, the first node and the third node perform data processing based on a transaction pool.

For example, when the consensus is reached, the first node and the third node respectively add a node frozen block formed by the node freeze transaction to the blockchains of the blockchain system respectively recorded by the first node and the third node, and block heights of the blockchains respectively recorded by the first node and the third node increase. Before the blockchains of the blockchain system respectively recorded by the first node and the third node reach the frozen block height, the first node and the third node perform subsequent data processing based on the transaction pool.

S407: When the first node determines that the first node does not reach the consensus on the node freeze proposal with the second node and the third node, the first node, the second node, and the third node perform data processing based on a transaction pool.

For example, when the consensus is not reached, the first node gives up the current round of consensus, and a next node rotates a master node to enter a next round of consensus process.

S408: When it is determined that no to-be-frozen node exists, the first node obtains a specified quantity of transactions from a transaction pool.

S409: The first node generates a transaction proposal based on the obtained transactions.

S410: The first node, the second node, and the third node perform data processing based on the transaction proposal.

A process of determining, based on the consensus algorithm, whether the consensus is reached on the node freeze proposal with the slave nodes is described in detail below.

After generating the node freeze proposal, the master node generates a master feedback result for the node freeze proposal, where the master feedback result is configured for representing that the master node agrees to execute the node freeze proposal; and the master node broadcasts the master feedback result to the slave nodes. Correspondingly, after receiving the node freeze proposal, the slave node may generate a corresponding slave feedback result for the node freeze proposal, where the slave feedback result is configured for representing whether the corresponding slave node agrees to execute the node freeze proposal. After generating the slave feedback result, the slave node may broadcast the generated slave feedback result to the master node and other slave nodes.

The master node receives slave feedback results respectively broadcast by the slave nodes, so that the master node may determine, based on the master feedback result and the received slave feedback results, whether the master node reaches the consensus on the node freeze proposal with the slave nodes.

When the master node receives the slave feedback results respectively broadcast by the slave nodes, the master node may start timing after broadcasting the node freeze proposal, may continuously receive, within specified duration, the slave feedback results respectively broadcast by the slave nodes for the node freeze proposal, and does not continuously receive a slave feedback result when an end moment of the specified duration is reached. The master node may alternatively determine a feedback quantity threshold according to a total quantity of the slave nodes, and does not continuously receive a slave feedback result when a quantity of received slave feedback results reaches the feedback quantity threshold. The master node may alternatively determine a feedback quantity threshold according to a preset maximum error amount, and does not continuously receive a slave feedback result when a quantity of received slave feedback results reaches the feedback quantity threshold. The maximum error amount is a maximum quantity of nodes that are misjudged and that are allowed by the blockchain system, or the like. This is not specifically limited. For example, if the maximum error amount is f, the feedback quantity threshold may be 2*f+1. In this case, when the quantity of slave feedback results received by the master node is greater than or equal to 2*f+1, the master node may not continuously receive a slave feedback result.

In an embodiment, when a quantity of the received slave feedback results is greater than a first quantity threshold, the master node may determine, based on the master feedback result and the received slave feedback results, whether the master node reaches the consensus on the node freeze proposal with the slave nodes, thereby avoiding misjudgment due to a small quantity of the received slave feedback results. The first quantity threshold may be the foregoing feedback quantity threshold or another value. This is not specifically limited.

The master node generates and broadcasts a master commit result based on the master feedback result and the received slave feedback results when the quantity of the received slave feedback results is greater than the first quantity threshold, the master commit result being configured for representing that the master node agrees to execute the node freeze proposal, and representing whether a quantity of nodes agreeing to execute the node freeze proposal in the slave nodes is greater than a second quantity threshold. The second quantity threshold may be a same value as the first quantity threshold, or may be a different value, or the like. This is not specifically limited.

After receiving the master feedback result broadcast by the master node and the slave feedback results broadcast by the other slave nodes, and when a quantity of the received feedback results is greater than the first quantity threshold, the slave node may also generate a corresponding slave commit result based on the slave feedback result generated by the slave node and the received master feedback result and slave feedback results, and broadcast the slave commit result generated by the slave node to the master node and the other slave nodes.

The master node receives slave commit results respectively broadcast by the slave nodes, the slave commit result being generated by the corresponding slave node based on the received master feedback result and received slave feedback results broadcast by other slave nodes; and the slave commit result being configured for representing whether the corresponding slave node agrees to execute the node freeze proposal, and representing whether a quantity of nodes agreeing to execute the node freeze proposal in the master node and the slave nodes is greater than the second quantity threshold.

The master node determines, based on the master commit result generated by the master node and the received slave commit results, whether the master node reaches the consensus on the node freeze proposal with the slave nodes.

In an embodiment, when a quantity of the received slave commit results is greater than a third quantity threshold, the master node may determine, based on the master commit result generated by the master node and the received slave commit results, whether the master node reaches the consensus on the node freeze proposal with the slave nodes, thereby avoiding misjudgment due to a small quantity of the received slave commit results. The third quantity threshold may be the foregoing feedback quantity threshold, the foregoing first quantity threshold, or another value. This is not specifically limited.

When the quantity of the received slave commit results is greater than the third quantity threshold, if the master commit result meets a first commit condition and a quantity of slave commit results meeting a second commit condition in the received slave commit results is greater than a fourth quantity threshold, the master node determines that the master node reaches the consensus on the node freeze proposal with the slave nodes. If the master commit result does not meet the first commit condition or the quantity of slave commit results meeting the second commit condition in the slave commit results received by the master node is less than or equal to the fourth quantity threshold, the master node determines that the master node does not reach the consensus on the node freeze proposal with the slave nodes. The fourth quantity threshold may be a same value as the third quantity threshold, or may be a different value, or the like. This is not specifically limited.

The first commit condition is that the master node agrees and a quantity of nodes agreeing in the slave nodes is greater than the second quantity threshold. The second commit condition is that the corresponding slave node agrees and the quantity of nodes agreeing in the master node and the slave nodes is greater than the second quantity threshold.

After receiving the master commit result broadcast by the master node and the slave commit results broadcast by the other slave nodes, and when a quantity of the received commit results is greater than the third quantity threshold, the slave node may also determine, based on the slave commit result generated by the slave node and the received master commit result and slave commit results, whether the slave node reaches the consensus on the node freeze proposal with the master node and the other slave nodes.

A method in which the slave node determines whether the slave node reaches the consensus on the node freeze proposal with the master node and the other slave nodes is similar to the method in which the master node determines whether the master node reaches the consensus on the node freeze proposal with the slave nodes.

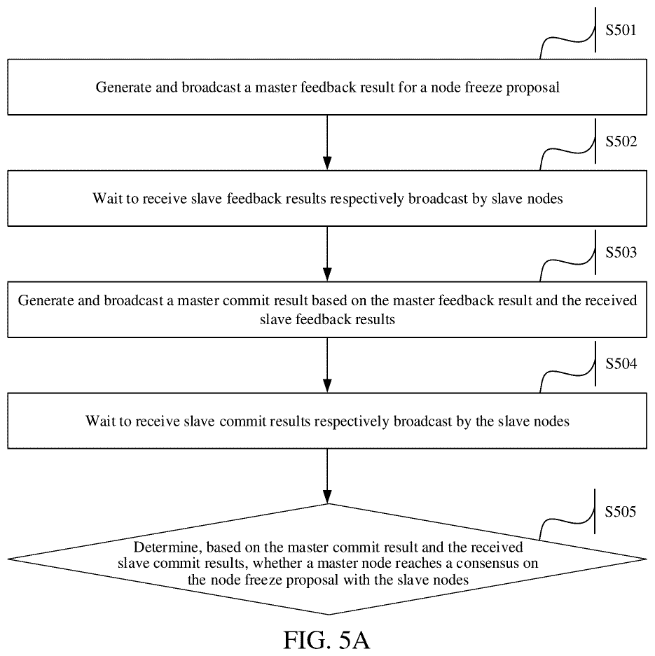

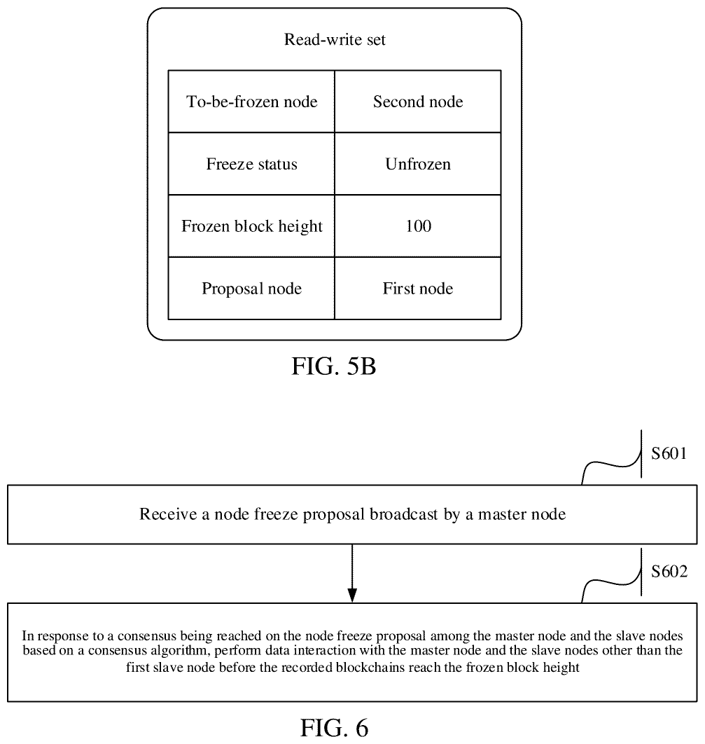

Based on FIG. 4, S405 is exemplarily introduced. Referring to FIG. 5A, a process after the first node broadcasts the node freeze proposal to the second node and the third node may be as follows:

S501: The master node generates and broadcasts a master feedback result for the node freeze proposal.

After generating the node freeze proposal, the master node may generate a read-write set for the node freeze transaction. The read-write set is configured for recording the to-be-frozen node indicated by the node freeze transaction, a freeze status of the to-be-frozen node, a frozen block height of the to-be-frozen node, a proposal node generating the node freeze proposal, and the like.

An example in which the second node is the to-be-frozen node is used. FIG. 5B shows a read-write set. The read-write set represents: A current freeze status of the second node is unfrozen, the frozen block height of the second node indicated by the node freeze transaction is 100, and the current node freeze transaction is generated by the first node.

The master node may use the generated read-write set as the master feedback result; or may use a hash code obtained through calculation on the read-write set by using a hash algorithm as the master feedback result; or may use, as the master feedback result, a comprehensive hash code obtained through calculation on the node frozen block formed by the node freeze transaction and the read-write set by using the hash algorithm; or the like. This is not specifically limited. The master feedback result may represent that the master node agrees on the node freeze proposal.

S502: The master node waits to receive slave feedback results respectively broadcast by the slave nodes.

After the master node broadcasts the node freeze proposal, the slave node may generate a corresponding slave feedback result for the received node freeze proposal, where the slave feedback result may represent whether the corresponding slave node agrees on the node freeze proposal.

If the slave feedback result is the read-write set generated by the corresponding slave node based on the node freeze transaction, the hash code of the read-write set, the comprehensive hash code of the node frozen block formed by the node freeze transaction and the read-write set, or the like, it indicates that the slave node agrees on the node freeze proposal. If the slave feedback result is specified content, for example, NilHash, it indicates that the slave node does not agree on the node freeze proposal.

After generating the slave feedback result, the slave node may broadcast the generated slave feedback result to the master node and the other slave node.

In this way, after broadcasting the node freeze proposal, the master node may wait to receive the slave feedback results respectively broadcast by the slave nodes. When it is determined that a quantity of the received slave feedback results is greater than a first quantity threshold, the master node performs S503, thereby avoiding a situation in which whether the nodes reach the consensus is misjudged due to a small quantity of the received slave feedback results.

S503: The master node generates and broadcasts a master commit result based on the master feedback result and the received slave feedback results.

The master node determines whether the master feedback result represents that the master node agrees on the node freeze proposal, determines that each of the received slave feedback results represents whether the corresponding slave node agrees on the node freeze proposal, and counts a quantity of slave nodes agreeing on the node freeze proposal.

If the master node agrees and the quantity of slave nodes agreeing is greater than a second quantity threshold, the master node may generate the master commit result based on the read-write set of the node freeze transaction, the hash code of the read-write set, the comprehensive hash code of the node frozen block formed by the node freeze transaction and the read-write set, or the like, where the master commit result further represents that the master node agrees.

If the master node does not agree or the quantity of slave nodes agreeing is not greater than the second quantity threshold, the master node may generate the master commit result based on the specified content, for example, NilHash, where the master commit result further represents that the master node does not agree.

S504: The master node waits to receive slave commit results respectively broadcast by the slave nodes.

After broadcasting the master feedback result, the master node may wait to receive the slave commit results respectively broadcast by the slave nodes. A process in which the slave node generates the slave commit result is similar to the process in which the master node generates the master commit result. Details refer to the embodiments described herein.

In this case, if the slave commit result is the read-write set of the node freeze transaction, the hash code of the read-write set, the comprehensive hash code of the node frozen block formed by the node freeze transaction and the read-write set, or the like, it indicates that the slave commit result further represents that the corresponding slave node agrees.

If the slave commit result is the specified content, for example, NilHash, it indicates that the slave commit result further represents that the corresponding slave node does not agree.

When a quantity of the received slave commit results is greater than a third quantity threshold, the master node performs S505, thereby avoiding a situation in which whether the nodes reach the consensus is misjudged due to a small quantity of the received slave commit results.

S505: The master node determines, based on the master commit result generated by the master node and the received slave commit results, whether the master node reaches the consensus on the node freeze proposal with the slave nodes.

The master node determines whether the master commit result further represents that the master node agrees, determines whether each of the received slave commit results further represents that the corresponding slave node agrees, and counts a quantity of slave commit results further representing that corresponding slave nodes agree.

If the master commit result further represents that the master node agrees and the counted quantity is greater than the second quantity threshold, the master node determines that the master node reaches the consensus on the node freeze proposal with the slave nodes. If the master commit result further represents that the master node does not agree or the counted quantity is not greater than the second quantity threshold, the master node determines that the master node does not reach the consensus on the node freeze proposal with the slave nodes.

The data processing method provided in the embodiments of this disclosure is described below in detail based on FIG. 1B by using a slave node in a blockchain system as a body. FIG. 6 is a schematic flowchart of a data processing method according to an embodiment of this disclosure.

S601: Receive a node freeze proposal broadcast by a master node.

The node freeze proposal is generated when the master node determines that a to-be-frozen node whose status information meets a freeze condition exists in slave nodes after the master node obtains status information of each of the slave nodes. The node freeze proposal is configured for representing a node freeze transaction of the to-be-frozen node. The node freeze transaction is configured for indicating to restrict data interaction with the to-be-frozen node before a blockchain of the blockchain system recorded by the corresponding slave node reaches a frozen block height.

S602: Perform, based on a consensus algorithm in response to that the master node reaches a consensus on the node freeze proposal with the slave nodes, data interaction with the master node and the slave nodes except the to-be-frozen node before the recorded blockchain of the blockchain system reaches the frozen block height.

When the master node reaches the consensus on the node freeze proposal with the slave nodes, the master node performs data interaction with the slave nodes except the to-be-frozen node before blockchains of the blockchain system respectively recorded by the nodes reach the frozen block height, for example, performs a data processing process based on a transaction pool. It is equivalent to that the to-be-frozen node is removed or frozen only when the master node reaches the consensus with the slave nodes, which indicates that the to-be-frozen node is removed or frozen only when most nodes cannot communicate with the to-be-frozen node or block heights recorded by most nodes are inconsistent with a block height recorded by the to-be-frozen node, thereby avoiding misjudgment.

Based on the consensus algorithm, if the master node reaches the consensus on the node freeze proposal with the slave nodes, the master node may add a node frozen block formed by the node freeze transaction to a blockchain of the blockchain system recorded by the master node, and a block height of the blockchain recorded by the master node also increases; and the slave node may add the node frozen block formed by the node freeze transaction to a blockchain of the blockchain system recorded by the slave node, and a block height of the blockchain recorded by the slave node also increases. In this way, the master node performs data interaction with the slave nodes except the to-be-frozen node before the blockchains of the blockchain system recorded by the nodes reach the frozen block height, thereby avoiding a stuck situation of data processing caused when the to-be-frozen node rotates a master node, and improving stability of the data processing process.

The following specifically describes a process in which the slave node determines, based on the consensus algorithm after receiving the node freeze proposal broadcast by the master node, whether the slave node reaches the consensus on the node freeze proposal with the master node and other slave nodes.

After receiving the node freeze proposal broadcast by the master node, the slave node may obtain status information of the master node and the status information of each of the slave nodes, and determine the status information of the to-be-frozen node in the slave nodes; or may directly obtain the status information of the to-be-frozen node; or the like. This is not specifically limited. Verification is performed on the node freeze transaction by determining whether the status information of the to-be-frozen node meets the freeze condition, to generate a corresponding slave feedback result.

When determining whether the status information of the to-be-frozen node meets the freeze condition, the slave node may determine whether a time difference between a historical communication moment between the slave node and the to-be-frozen node and a current moment is greater than a preset duration threshold, and determine whether a height difference between a slave node block height of the slave node and a slave node block height of the to-be-frozen node is greater than a preset height difference threshold.

If the slave node determines that the time difference between the historical communication moment between the slave node and the to-be-frozen node and the current moment is greater than the preset duration threshold, and the height difference between the slave node block height of the slave node and the slave node block height of the to-be-frozen node is greater than the preset height difference threshold, the slave node may generate the corresponding slave feedback result, where the slave feedback result represents that the slave node agrees on the node freeze proposal.

The slave node may use the frozen block height indicated by the node freeze proposal as the slave feedback result, or may use a hash code of a node frozen block formed by the node freeze transaction in the node freeze proposal as the slave feedback result, or may use a read-write set generated based on the node freeze transaction as the slave feedback result, or may use a hash code of the read-write set as the slave feedback result, or may use a comprehensive hash code of the node frozen block and the read-write set as the slave feedback result, or the like. Details are similar to a master feedback result generated by the master node, as described in the other embodiments herein.

If the slave node determines that the time difference between the historical communication moment between the slave node and the to-be-frozen node and the current moment is not greater than the preset duration threshold, and the height difference between the slave node block height of the slave node and the slave node block height of the to-be-frozen node is not greater than the preset height difference threshold, the slave node may use specified content as the slave feedback result, for example, use NilHash as the slave feedback result, where the slave feedback result represents that the slave node does not agree on the node freeze proposal.

In this way, through the slave feedback result generated by the slave node, it may be determined whether the slave node reaches the consensus on the node freeze proposal with the master node and the other slave nodes.

In an embodiment, after the slave node receives the node freeze proposal broadcast by the master node, if the master node and the slave nodes each are associated with a freeze status, and the freeze status is frozen or unfrozen, verification may also be performed on the node freeze proposal in another manner, thereby ensuring accuracy of the consensus process.

The slave node obtains the status information of the master node and the status information of each of the other slave nodes. For the status information, reference may be made to the foregoing descriptions. When it is determined that a freeze status of the to-be-frozen node is unfrozen, it indicates that the to-be-frozen node is currently in a situation in which the to-be-frozen node may be frozen. In this case, the slave node may further determine whether the status information of the to-be-frozen node meets the freeze condition. If the status information of the to-be-frozen node meets the freeze condition, the slave node may determine a target block height for restricting data interaction with the to-be-frozen node based on a preset freeze policy. In this way, based on the obtained target block height, it may be determined whether the slave node reaches the consensus on the node freeze proposal with the master node and the other slave nodes.

If the status information of the to-be-frozen node does not meet the freeze condition, the specified content may be used as the slave feedback result, for example, NilHash is used as the slave feedback result, where the slave feedback result represents that the slave node does not agree on the node freeze proposal. In this way, through the slave feedback result generated by the slave node, it may be determined whether the slave node reaches the consensus on the node freeze proposal with the master node and the other slave nodes.

In an embodiment, when it is determined that the freeze status of the to-be-frozen node is frozen, it indicates that the to-be-frozen node is currently in a situation in which the to-be-frozen node cannot be repeatedly frozen. In this case, the slave node may determine whether the to-be-frozen node needs to be continuously frozen by determining whether the blockchain of the blockchain system recorded by the slave node reaches a historical block height. The historical block height is configured for representing a block height range that is indicated by a historical freeze proposal and that is for restricting data interaction with the to-be-frozen node. The historical freeze proposal is a proposal generated for the to-be-frozen node before the node freeze proposal. In other words, the historical block height is a frozen block height at which the to-be-frozen node is indicated not to participate in the data processing process last time.

If the blockchain of the blockchain system recorded by the slave node reaches the historical block height, it indicates that the to-be-frozen node may be continuously frozen currently. In this case, a target block height for restricting data interaction with the to-be-frozen node may be determined based on a preset freeze policy. In this way, based on the obtained target block height, it may be determined whether the slave node reaches the consensus on the node freeze proposal with the master node and the other slave nodes.

If the blockchain of the blockchain system recorded by the slave node does not reach the historical block height, it indicates that the to-be-frozen node is currently still in the freeze status and the to-be-frozen node cannot be repeatedly frozen. In this case, the specified content may be used as the slave feedback result, for example, NilHash is used as the slave feedback result, where the slave feedback result represents that the slave node does not agree on the node freeze proposal. In this way, through the slave feedback result generated by the slave node, it may be determined whether the slave node reaches the consensus on the node freeze proposal with the master node and the other slave nodes.

In an embodiment, when determining, based on the obtained target block height, whether the slave node reaches the consensus on the node freeze proposal with the master node and the other slave nodes, the slave node may match the target block height with the frozen block height indicated by the node freeze transaction, and generate and broadcast a slave feedback result. The slave feedback result is configured for representing whether the corresponding slave node agrees to execute the node freeze proposal.

If the target block height determined by the slave node matches the frozen block height indicated by the master node through the node freeze transaction, the slave node may generate the slave feedback result, where the slave feedback result represents that the slave node agrees on the node freeze proposal. For specific content of the slave feedback result, reference may be made to the foregoing descriptions. That the target block height determined by the slave node matches the frozen block height indicated by the master node through the node freeze transaction may be that the target block height determined by the slave node is the same as the frozen block height indicated by the master node through the node freeze transaction, or the like. This is not specifically limited.

If the target block height determined by the slave node does not match the frozen block height indicated by the master node through the node freeze transaction, the slave node may generate the slave feedback result, where the slave feedback result represents that the slave node does not agree on the node freeze proposal. For specific content of the slave feedback result, reference may be made to the foregoing descriptions.

When broadcasting the slave feedback result generated by the slave node, the slave node may wait to receive a master feedback result broadcast by the master node, and receive slave feedback results broadcast by the other slave nodes. The master feedback result may be configured for representing that the master node agrees to execute the node freeze proposal. In this way, the slave node may determine, based on the obtained master feedback result and slave feedback results, whether the slave node reaches the consensus on the node freeze proposal with the master node and the other slave nodes.

In an embodiment, when a quantity of the received feedback results is greater than a first quantity threshold, the slave node may determine, based on the obtained master feedback result and slave feedback results, whether the slave node reaches the consensus on the node freeze proposal with the master node and the other slave nodes, thereby avoiding misjudgment due to a small quantity of the received feedback results. The first quantity threshold may be the first quantity threshold for determining by the master node described above or another value. This is not specifically limited.

When the quantity of the obtained master feedback result and slave feedback results is greater than the first quantity threshold, the slave node may generate and broadcast a slave commit result based on the obtained master feedback result and slave feedback results. The slave commit result is configured for representing whether the corresponding slave node agrees to execute the node freeze proposal, and representing whether a quantity of nodes agreeing to execute the node freeze proposal in the master node and the other slave nodes is greater than a second quantity threshold; The second quantity threshold may be a same value as the first quantity threshold, or may be a different value, or the like. This is not specifically limited.

In addition, the slave node may wait to receive a master commit result broadcast by the master node, and receive slave commit results broadcast by the other slave nodes. The master commit result is generated by the master node based on the received slave feedback results broadcast by the slave nodes. The master commit result is configured for representing that the master node agrees to execute the node freeze proposal, and representing whether a quantity of nodes agreeing to execute the node freeze proposal in the slave nodes is greater than the second quantity threshold. For details, reference is made to the foregoing descriptions of the master node.

The slave node may obtain the master commit result and the slave commit results based on the slave commit result generated by the slave node, the received slave commit results, and the received master commit result, so that the slave node may determine, based on the obtained master commit result and slave commit results, whether the slave node reaches the consensus on the node freeze proposal with the master node and the other slave nodes.

In an embodiment, when a quantity of the received commit results is greater than a third quantity threshold, the slave node may determine, based on the obtained master commit result and slave commit results, whether the slave node reaches the consensus on the node freeze proposal with the master node and the other slave nodes, thereby avoiding misjudgment due to a small quantity of the received commit results. The third quantity threshold may be the foregoing first quantity threshold or another value. This is not specifically limited.

When the quantity of the obtained master commit result and slave commit results is greater than the third quantity threshold, if the generated slave commit result meets a first commit condition and a quantity of commit results meeting a second commit condition in the received slave commit results and master commit result is greater than a fourth quantity threshold, the slave node determines that the slave node reaches the consensus on the node freeze proposal with the master node and the other slave nodes.

If the generated slave commit result does not meet the first commit condition or the quantity of commit results meeting the second commit condition in the received slave commit results and master commit results is not greater than the fourth quantity threshold, the slave node determines that the slave node does not reach the consensus on the node freeze proposal with the master node and the other slave nodes. The fourth quantity threshold may be a same value as the third quantity threshold, or may be a different value, or the like. This is not specifically limited.

The first commit condition is that the corresponding slave node agrees and the quantity of nodes agreeing in the master node and the other slave nodes is greater than the second quantity threshold. The second commit condition is that a corresponding master node or corresponding other slave nodes agree and the quantity of nodes agreeing in the master node and the other slave nodes is greater than the second quantity threshold.

A method in which the slave node determines whether the slave node reaches the consensus on the node freeze proposal with the master node and the other slave nodes is similar to the method in which the master node determines whether the master node reaches the consensus on the node freeze proposal with the slave nodes. For details, reference may be made to the foregoing descriptions.

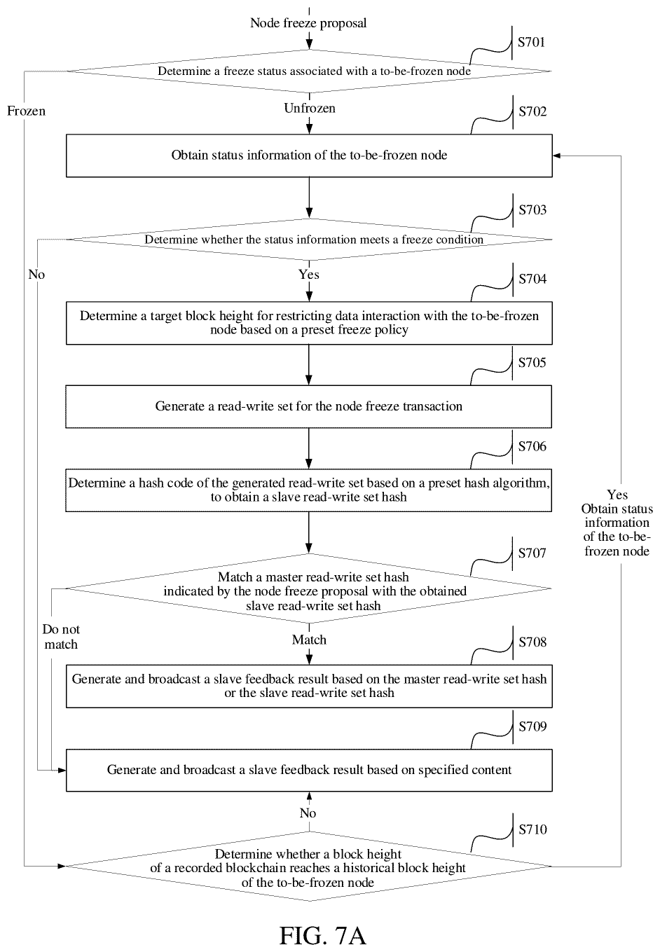

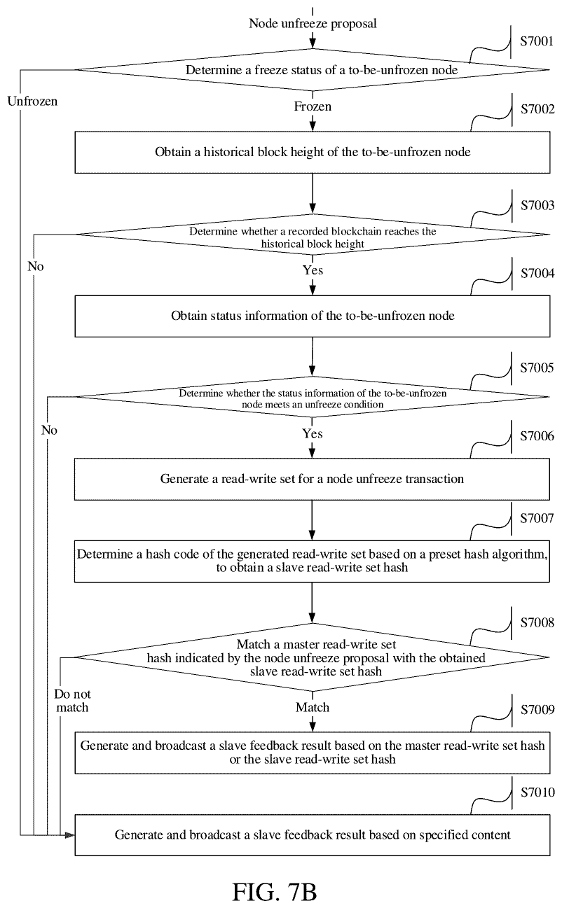

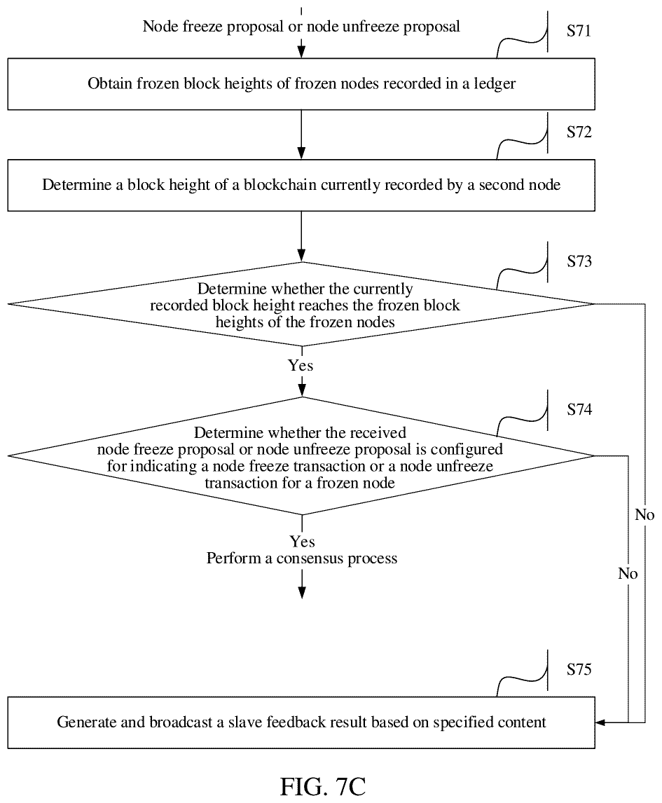

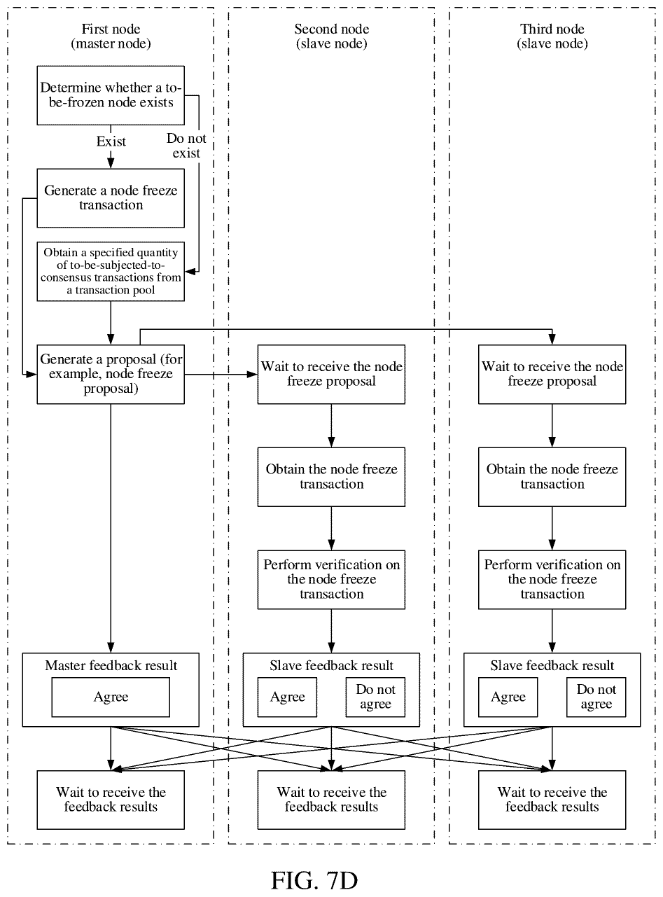

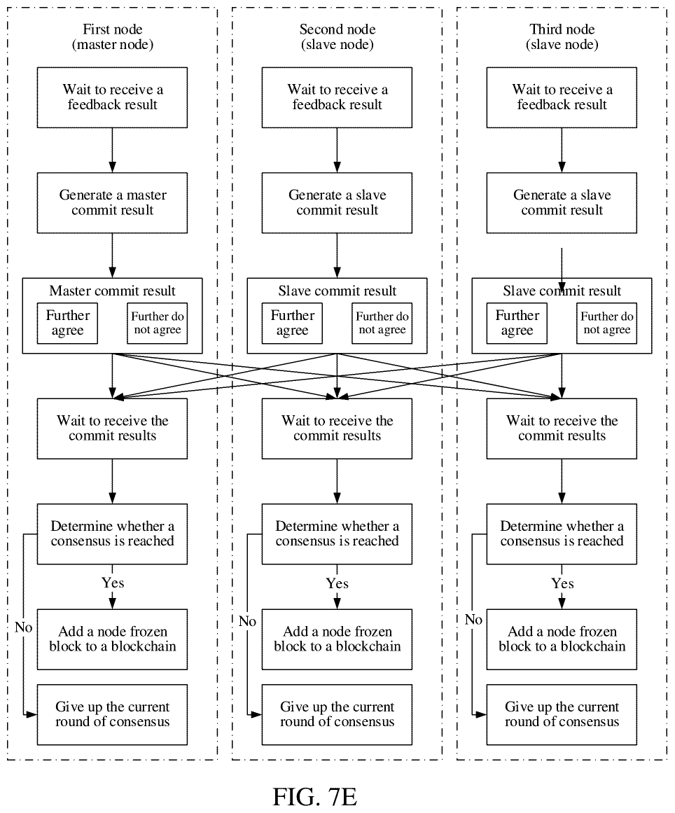

For example, the blockchain system still includes three nodes, that is, a first node, a second node, and a third node. The first node rotates a master node in a current round, and the second node and the third node are slave nodes. In this case, referring to FIG. 7A, an example of a process in which the second node determines whether the second node reaches a consensus on a node freeze proposal with the first node and the third node is described below. A to-be-frozen node may be the second node or the third node.

S701: The second node determines a freeze status associated with the to-be-frozen node.

After receiving the node freeze proposal, the second node may determine the to-be-frozen node indicated by the node freeze proposal. The second node may obtain the freeze status of the to-be-frozen node, so that the second node may determine whether the to-be-frozen node is frozen or unfrozen.

S702: The second node may obtain status information of the to-be-frozen node when the freeze status associated with the to-be-frozen node is unfrozen.

When the freeze status associated with the to-be-frozen node is unfrozen, it indicates that the to-be-frozen node may be currently frozen. In this case, the second node may obtain the status information of the to-be-frozen node, and perform S703 to S708 based on the status information, to freeze the to-be-frozen node.

S703: The second node determines whether the status information meets a freeze condition.

When it is determined that the status information meets the freeze condition, the second node performs S704 to S708. When it is determined that the status information does not meet the freeze condition, the second node performs S709.

S704: The second node may determine a target block height for restricting data interaction with the to-be-frozen node based on a preset freeze policy.

S705: The second node generates a read-write set for the node freeze transaction.

If the node freeze proposal further includes a hash code of a read-write set generated by the first node for the node freeze transaction, the hash code is denoted as a master read-write set hash, where the read-write set generated by the first node for the node freeze transaction includes a frozen block height of the to-be-frozen node indicated by the node freeze transaction.

In this case, the second node may generate a read-write set for the node freeze transaction indicated by the received node freeze proposal, where the read-write set includes the target block height of the to-be-frozen node determined by the second node. The second node performs S706 to S708, to determine a hash code of the generated read-write set, and denote the hash code as a slave read-write set hash. In this way, the first node may match the frozen block height with the target block height by matching the master read-write set hash and the slave read-write set hash. In addition, according to the foregoing descriptions, because the read-write set may further include other information, verification can be more comprehensively performed on the node freeze proposal by matching the master read-write set hash with the slave read-write set hash, thereby improving accuracy of a consensus process.

S706: The second node determines the hash code of the generated read-write set based on a preset hash algorithm, to obtain the slave read-write set hash.

S707: The second node matches the master read-write set hash indicated by the node freeze proposal with the obtained slave read-write set hash.

The master read-write set hash is the hash code of the read-write set determined based on the read-write set generated by the master node for the node freeze transaction. The second node may determine whether the master read-write set hash is the same as the slave read-write set hash generated by the second node. If the master read-write set hash is the same as the slave read-write set hash, it is determined that the master read-write set hash matches the slave read-write set hash; if the master read-write set hash is different from the slave read-write set hash, it is determined that the master read-write set hash does not match the slave read-write set hash; or the like. This is not specifically limited.

S708: When it is determined that the master read-write set hash matches the slave read-write set hash, the second node may generate and broadcast a slave feedback result based on the master read-write set hash or the slave read-write set hash, where the slave feedback result represents that the second node agrees on the node freeze proposal.

Based on the slave feedback result, the second node may perform a consensus process with the first node and the third node, to determine whether the first node, the second node, and the third node reach the consensus on the node freeze proposal.

If the consensus is reached, the second node may remove the to-be-frozen node from a node list stored by the second node. The node list may be nodes recorded by the second node that participate in a data processing process, so that the node list is modified based on opinions of most nodes in the blockchain system rather than an opinion of the second node alone, thereby improving accuracy of a process of modifying the node list.

If the consensus is not reached, the second node ends the current round of consensus process, a master node of a next round of consensus process is determined, the next round of consensus process is entered, and the like.

When it is determined that the master read-write set hash does not match the slave read-write set hash, the second node performs S709.

S709: The second node generates and broadcasts a slave feedback result based on specified content, where the slave feedback result represents that the second node does not agree on the node freeze proposal. The specified content may be NilHash, or the like. This is not specifically limited.

S710: When the freeze status associated with the to-be-frozen node is frozen, the second node determines whether a block height of a recorded blockchain reaches a historical block height of the to-be-frozen node. The historical block height may be obtained through frozen block heights of frozen nodes recorded in a ledger.

When it is determined that the block height of the recorded blockchain reaches the historical block height of the to-be-frozen node, it indicates that the to-be-frozen node may be continuously frozen. In this case, the second node obtains the status information of the to-be-frozen node, and performs S703 to S708.

When it is determined that the block height of the recorded blockchain does not reach the historical block height of the to-be-frozen node, it indicates that the to-be-frozen node has been frozen and the to-be-frozen node cannot be repeatedly frozen. In this case, the second node performs S709.

In an embodiment, when the block height of the recorded blockchain reaches the frozen block height of the frozen node recorded in the ledger, the master node may further determine the frozen node as a to-be-unfrozen node, and generate a node unfreeze proposal for the to-be-unfrozen node. The master node broadcasts the node unfreeze proposal to the slave nodes except the to-be-unfrozen node. When the master node reaches a consensus on the node unfreeze proposal with the slave nodes, the master node may perform data interaction with the slave nodes including the to-be-unfrozen node, for example, perform a data processing process based on the transaction pool, to unfreeze the to-be-unfrozen node. In this way, after an abnormal node is frozen or removed, if the node has been restored to normal, the node may be unfrozen in time, so that the node can perform data interaction to participate in the data processing process after the node is frozen or removed. Through participation of all normal nodes, accuracy of the consensus process can be improved.

Therefore, after the slave node performs data interaction with the master node and other slave nodes except the to-be-frozen node, for example, performs data processing based on the transaction pool, the slave node may further receive the node unfreeze proposal broadcast by the master node. The node unfreeze proposal is generated when the master node determines that a to-be-unfrozen node whose status information meets an unfreeze condition exists in the slave nodes after the master node obtains the status information of each of the slave nodes. The node unfreeze proposal is configured for representing a node unfreeze transaction of the to-be-unfrozen node. The node unfreeze transaction is configured for indicating to perform data interaction with the to-be-unfrozen node when a blockchain of the blockchain system recorded by the corresponding slave node reaches an unfrozen block height. For details, reference may be made to the process of unfreezing by the master node described above.

When the slave node determines, based on the consensus algorithm, that the slave node reaches the consensus on the node unfreeze proposal with the master node and the other slave nodes except the to-be-unfrozen node, the slave node performs data interaction with the master node, the to-be-unfrozen node, and the other slave nodes when the recorded blockchain of the blockchain system reaches the unfrozen block height, for example, performs the data processing process based on the transaction pool.

In an embodiment, after receiving the node unfreeze proposal, the slave node may perform verification on the node unfreeze proposal, to determine whether the slave node reaches the consensus on the node unfreeze proposal with the master node and the other slave nodes except the to-be-unfrozen node.

If the master node and the slave node each are associated with a freeze status and the freeze status is frozen or unfrozen, the slave node may first determine a freeze status of the to-be-unfrozen node, and further determine, when the freeze status is frozen, whether the status information of the to-be-unfrozen node meets the unfreeze condition, to perform verification on the node unfreeze proposal.

The slave node obtains the status information of the to-be-unfrozen node when it is determined that the freeze status of the to-be-unfrozen node is frozen; and determines, based on the consensus algorithm when it is determined that the status information of the to-be-unfrozen node meets the unfreeze condition, whether the slave node reaches the consensus on the node unfreeze proposal with the master node and the other slave nodes except the to-be-unfrozen node.

If the freeze status of the to-be-unfrozen node is frozen, it indicates that the to-be-unfrozen node may be a node that needs to be unfrozen. Therefore, the slave node may further determine whether the status information of the to-be-unfrozen node meets the unfreeze condition, to determine whether the slave node agrees on the node unfreeze proposal. If the status information of the to-be-unfrozen node meets the unfreeze condition, the slave node may generate and broadcast a slave feedback result, where the slave feedback result represents that the slave node agrees to execute the node unfreeze proposal, so that the slave node may determine, based on the slave feedback result, whether the slave node reaches the consensus on the node unfreeze proposal with the master node and the other slave nodes except the to-be-unfrozen node. For details, reference may be made to the foregoing descriptions of the node freeze proposal.

When it is determined that the freeze status of the to-be-unfrozen node is unfrozen, the slave node may directly determine, based on the consensus algorithm, that the slave node reaches the consensus on the node unfreeze proposal with the master node and the other slave nodes except the to-be-unfrozen node.

If the freeze status of the to-be-unfrozen node is unfrozen, it indicates that the to-be-unfrozen node has been unfrozen and does not need to be repeatedly unfrozen, the slave node may generate and broadcast a slave feedback result, where the slave feedback result represents that the slave node does not agree to execute the node unfreeze proposal, so that the slave node may determine, based on the slave feedback result, whether the slave node reaches the consensus on the node unfreeze proposal with the master node and the other slave nodes except the to-be-unfrozen node. For details, reference may be made to the foregoing descriptions of the node freeze proposal.

For example, the blockchain system includes four nodes, that is, a first node, a second node, a third node, and a fourth node. The first node rotates a master node in a current round, and the second node, the third node, and the fourth node are slave nodes. In this case, referring to FIG. 7B, an example of a process in which the second node determines whether the second node reaches a consensus on a node unfreeze proposal with the first node and the third node is described below. A to-be-unfrozen node is the fourth node.

S7001: The second node determines a freeze status of the to-be-unfrozen node.

After receiving the node unfreeze proposal, the second node may determine the to-be-unfrozen node indicated by the node unfreeze proposal. The second node may obtain the freeze status of the to-be-unfrozen node, so that the second node may determine whether the to-be-unfrozen node is frozen or unfrozen.

When the freeze status associated with the to-be-unfrozen node is frozen, it indicates that the to-be-unfrozen node may be currently unfrozen. In this case, the second node performs S7002 to S7009, to unfreeze the to-be-unfrozen node.

When the freeze status associated with the to-be-unfrozen node is unfrozen, it indicates that the to-be-frozen node has been frozen and the to-be-frozen node cannot be repeatedly frozen. In this case, the second node performs S7010.

S7002: The second node obtains a historical block height of the to-be-unfrozen node.

The historical block height is configured for representing a block height range that is indicated by a historical freeze proposal and that is for restricting data interaction with the to-be-unfrozen node. The historical freeze proposal is a proposal generated for the to-be-unfrozen node before the node unfreeze proposal. In other words, the historical block height is a frozen block height indicated when the to-be-unfrozen node is frozen before.

S7003: The second node determines whether a recorded blockchain reaches the historical block height.

If the blockchain recorded by the second node reaches the historical block height, it indicates that the to-be-unfrozen node may be unfrozen. In this case, the second node performs S7004 to S7009, to unfreeze the to-be-unfrozen node. If the blockchain recorded by the second node does not reach the historical block height, it indicates that the to-be-unfrozen node still needs to be continuously frozen and cannot be unfrozen. In this case, the second node performs S7010.

S7004: The second node obtains status information of the to-be-unfrozen node.

For the status information, reference may be made to the foregoing descriptions.

S7005: The second node determines whether the status information of the to-be-unfrozen node meets an unfreeze condition.

The unfreeze condition may be opposite to a freeze condition. For example, if a communication connection status in the status information includes a historical communication moment, reference is made to the foregoing descriptions for details; and if a status of a blockchain in the status information includes a slave node block height, reference is made to the foregoing descriptions for details. In this case, the unfreeze condition may be that a time difference between a historical communication moment between the second node and the to-be-unfrozen node and a current moment is not greater than a preset duration threshold, a height difference between a slave node block height of the second node and the slave node block height of the to-be-unfrozen node is not greater than a preset height difference threshold, and the like. This is not specifically limited. The slave node block height of the to-be-unfrozen node is a block height of the blockchain of the blockchain system recorded by the to-be-unfrozen node. The unfreeze condition may alternatively be another condition. This is not specifically limited.

If the status information of the to-be-unfrozen node meets the unfreeze condition, the second node performs S7006 to S7009. If the status information of the to-be-unfrozen node does not meet the unfreeze condition, the second node performs S7010.

S7006: The second node generates a read-write set for the node unfreeze transaction.

If the node unfreeze proposal further includes a hash code of a read-write set generated by the first node for the node unfreeze transaction, the hash code is denoted as a master read-write set hash, where the read-write set generated by the first node for the node unfreeze transaction includes an unfrozen block height of the to-be-unfrozen node indicated by the node unfreeze transaction.

In this case, the second node may generate a read-write set for the node unfreeze transaction indicated by the received node unfreeze proposal, where the read-write set includes a target block height of the to-be-unfrozen node determined by the second node. The second node performs S7007 to S7009, to determine a hash code of the generated read-write set, and denote the hash code as a slave read-write set hash. In this way, the first node may match the unfrozen block height with the target block height by matching the master read-write set hash and the slave read-write set hash. In addition, according to the foregoing descriptions, because the read-write set may further include other information, verification can be more comprehensively performed on the node unfreeze proposal by matching the master read-write set hash with the slave read-write set hash, thereby improving accuracy of a consensus process.

S7007: The second node determines the hash code of the generated read-write set based on a preset hash algorithm, to obtain the slave read-write set hash.

S7008: The second node matches the master read-write set hash indicated by the node unfreeze proposal with the obtained slave read-write set hash.

The master read-write set hash is the hash code of the read-write set determined based on the read-write set generated by the master node for the node unfreeze transaction. The second node may determine whether the master read-write set hash is the same as the slave read-write set hash generated by the second node. If the master read-write set hash is the same as the slave read-write set hash, it is determined that the master read-write set hash matches the slave read-write set hash; if the master read-write set hash is different from the slave read-write set hash, it is determined that the master read-write set hash does not match the slave read-write set hash; or the like. This is not specifically limited.

S7009: When it is determined that the master read-write set hash matches the slave read-write set hash, the second node may generate and broadcast a slave feedback result based on the master read-write set hash or the slave read-write set hash, where the slave feedback result represents that the second node agrees on the node unfreeze proposal.

Based on the slave feedback result, the second node may perform a consensus process with the first node and the third node, to determine whether the first node, the second node, and the third node reach the consensus on the node unfreeze proposal.

If the consensus is reached, the second node may add the to-be-unfrozen node to a node list stored by the second node. The node list may be nodes recorded by the second node that participate in a data processing process, so that the node list is modified based on opinions of most nodes in the blockchain system rather than an opinion of the second node alone, thereby improving accuracy of a process of modifying the node list.

If the consensus is not reached, the second node ends the current round of consensus process, a master node of a next round of consensus process is determined, the next round of consensus process is entered, and the like.

When it is determined that the master read-write set hash does not match the slave read-write set hash, the second node performs S7010.

S7010: The second node generates and broadcasts a slave feedback result based on specified content, where the slave feedback result represents that the second node does not agree on the node freeze proposal. The specified content may be NilHash, or the like. This is not specifically limited.

Based on FIG. 7A and FIG. 7B, after obtaining a node freeze proposal or a node unfreeze proposal, the slave node may obtain frozen block heights of frozen nodes recorded in a ledger, and determine, based on a block height of a blockchain recorded by the slave node, whether a currently recorded block height has reached the frozen block heights of the frozen nodes. In this way, when it is determined that the currently recorded block height has reached a frozen block height of a frozen node, the slave node may further determine whether a node freeze proposal or a node unfreeze proposal for the frozen node is received, to perform verification on the node freeze proposal or the node unfreeze proposal received by the slave node, to generate a slave feedback result, perform a consensus process based on the slave feedback result, and the like.

For example, the blockchain system still includes three nodes, that is, a first node, a second node, and a third node. The first node rotates a master node in a current round, and the second node and the third node are slave nodes. In this case, referring to FIG. 7C, an example of a process in which the second node performs verification on the received node freeze proposal or node unfreeze proposal is described below.

S71: The second node obtains frozen block heights of frozen nodes recorded in a ledger.

S72: The second node determines a block height of a blockchain currently recorded by the second node.

S73: The second node determines whether the currently recorded block height reaches the frozen block heights of the frozen nodes.

When the currently recorded block height reaches a frozen block height of a frozen node, it indicates that the frozen node currently needs to be unfrozen or continuously frozen. In this case, the second node performs S74. When the currently recorded block height does not reach a frozen block height of a frozen node, it indicates that no node currently needs to be unfrozen or continuously frozen. In this case, the second node performs S75.

S74: The second node determines whether the received node freeze proposal or node unfreeze proposal is configured for indicating a node freeze transaction or a node unfreeze transaction for the frozen node.

When the received node freeze proposal or node unfreeze proposal is configured for indicating the node freeze transaction or the node unfreeze transaction for the frozen node, the second node generates and broadcasts a slave feedback result, where the slave feedback result represents that the second node agrees on the received node freeze proposal or node unfreeze proposal. The second node performs a consensus process with the first node and the third node based on the slave feedback result.

When the received node freeze proposal or node unfreeze proposal is not configured for indicating the node freeze transaction or the node unfreeze transaction for the frozen node, the second node performs S75.

S75: The second node generates and broadcasts a slave feedback result based on specified content, where the slave feedback result represents that the second node does not agree on the received node freeze proposal or node unfreeze proposal. The specified content may be NilHash, or the like. This is not specifically limited.

For example, the blockchain system still includes three nodes, that is, a first node, a second node, and a third node. The first node rotates a master node in a current round, and the second node and the third node are slave nodes. A process in which the first node, the second node, and the third node perform data processing is described below by using a data processing situation as an example. FIG. 7D shows a proposal stage, and FIG. 7E shows a feedback stage and a commit stage.

After the master node and the slave nodes are determined, the proposal stage is entered.

The first node obtains status information of the second node and status information of the third node. The first node determines, based on the status information of the second node and the status information of the third node, whether a to-be-frozen node whose status information meets a freeze condition exists in the second node and the third node.

When the first node determines that the to-be-frozen node whose status information meets the freeze condition exists in the second node and the third node, the first node generates a node freeze transaction for the to-be-frozen node.

When the first node determines that the to-be-frozen node whose status information meets the freeze condition does not exist in the second node and the third node, the first node obtains a specified quantity of to-be-subjected-to-consensus transactions from a transaction pool.

The first node generates a corresponding proposal based on the obtained node freeze transaction or to-be-subjected-to-consensus transactions. For example, the first node generates the node freeze transaction. The first node generates a node freeze proposal based on the node freeze transaction, and broadcasts the node freeze proposal to the second node and the third node.

The second node and the third node each wait to receive the node freeze proposal broadcast by the first node.

After obtaining the node freeze proposal, the second node and the third node obtain the node freeze transaction indicated by the node freeze proposal.

The second node and the third node perform verification on the node freeze transaction, to generate corresponding slave feedback results. The slave feedback result represents whether the corresponding slave node agrees to execute the node freeze proposal.

After generating the node freeze proposal, the first node generates a master feedback result, and broadcasts the master feedback result to the second node and the third node. The master feedback result represents that the first node agrees to execute the node freeze proposal.

After generating the slave feedback result, the second node broadcasts the slave feedback result to the first node and the third node. After generating the slave feedback result, the third node broadcasts the slave feedback result to the first node and the second node.

After the nodes each broadcast the generated feedback result, the feedback stage is entered.

The first node waits to receive the slave feedback results broadcast by the second node and the third node, and the second node and the third node each wait to receive the master feedback result broadcast by the first node and the slave feedback result broadcast by the other slave node.

The first node determines whether the first node agrees to execute the node freeze proposal, and determines whether a quantity of nodes agreeing to execute the node freeze proposal in the second node and the third node is greater than a second quantity threshold. The second node determines whether the second node agrees to execute the node freeze proposal, and determines whether a quantity of nodes agreeing to execute the node freeze proposal in the first node and the third node is greater than the second quantity threshold. The third node determines whether the third node agrees to execute the node freeze proposal, and determines whether a quantity of nodes agreeing to execute the node freeze proposal in the first node and the second node is greater than the second quantity threshold.

In this way, the first node generates a master commit result, and the second node and the third node each generate a corresponding slave commit result. The master commit result may represent whether the first node further agrees to execute the node freeze proposal. The slave commit result may represent whether the corresponding slave node further agrees to execute the node freeze proposal.

The first node broadcasts the master commit result, and the second node and the third node each broadcast the generated slave commit result.

After the nodes each broadcast the generated commit result, the commit stage is entered.

The first node waits to receive the slave commit results broadcast by the second node and the third node, and the second node and the third node each wait to receive the master commit result broadcast by the first node and the slave commit result broadcast by the other slave node.

The first node determines whether the first node further agrees to execute the node freeze proposal, and determines whether a quantity of nodes further agreeing to execute the node freeze proposal in the second node and the third node is greater than the second quantity threshold. The second node determines whether the second node further agrees to execute the node freeze proposal, and determines whether a quantity of nodes further agreeing to execute the node freeze proposal in the first node and the third node is greater than the second quantity threshold. The third node determines whether the third node further agrees to execute the node freeze proposal, and determines whether a quantity of nodes further agreeing to execute the node freeze proposal in the first node and the second node is greater than the second quantity threshold.

In this way, the first node, the second node, and the third node may determine whether a consensus is reached on the node freeze proposal.

If the consensus is reached, the first node, the second node, and the third node add a node frozen block formed by the node freeze transaction to respectively recorded blockchains, so that block height of the respectively recorded blockchains increase. In this way, the to-be-frozen node does not participate in a data processing process before the respectively recorded blockchains reach a frozen block height of the to-be-frozen node.

If the consensus is not reached, the first node, the second node, and the third node give up the current round of consensus process, a next master node is rotated, and a next round of consensus process is entered.

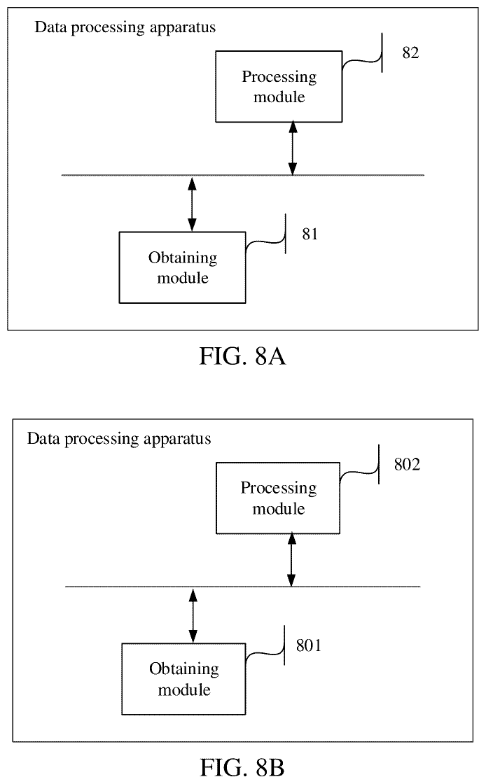

Based on the same inventive concept, an embodiment of this disclosure provides a data processing apparatus, applied to a master node in a plurality of nodes included in a blockchain system. The plurality of nodes further include a plurality of slave nodes associated with the master node, so that functions corresponding to the foregoing data processing method can be achieved. Referring to FIG. 8A, the apparatus includes an obtaining module 81 and a processing module 82.

The obtaining module 81 is configured to obtain status information of each of the slave nodes, the status information including a communication connection status of the corresponding slave node and a status of a blockchain of the blockchain system recorded by the slave node.

The processing module 82 is configured to generate and broadcast a node freeze proposal when it is determined that a to-be-frozen node whose status information meets a freeze condition exists in the slave nodes, the node freeze proposal being configured for representing a node freeze transaction of the to-be-frozen node; and the node freeze transaction being configured for indicating to restrict data interaction with the to-be-frozen node before a blockchain of the blockchain system recorded by the corresponding slave node reaches a frozen block height.

The processing module 82 is further configured to perform, based on a consensus algorithm in response to that the master node reaches a consensus on the node freeze proposal with the slave nodes, data interaction with the slave nodes except the to-be-frozen node before the recorded blockchain of the blockchain system reaches the frozen block height.

In an embodiment, the processing module 82 is further configured to:
before the performing data interaction with the slave nodes except the to-be-frozen node, generate a master feedback result for the node freeze proposal, and broadcast the master feedback result to the slave nodes, the master feedback result being configured for representing that the master node agrees to execute the node freeze proposal;
receive slave feedback results broadcast by slave nodes, the slave feedback result being configured for representing whether the corresponding slave node agrees to execute the node freeze proposal; and
determine, based on the master feedback result and the received slave feedback results, that the consensus is reached on the node freeze proposal with the slave nodes.

In an embodiment, the processing module 82 is further configured to:
generate and broadcast a master commit result based on the master feedback result and the received slave feedback results when a quantity of the received slave feedback results is greater than a first quantity threshold, the master commit result being configured for representing that the master node agrees to execute the node freeze proposal, and representing whether a quantity of nodes agreeing to execute the node freeze proposal in the slave nodes is greater than a second quantity threshold;
receive slave commit results respectively broadcast by the slave nodes, the slave commit result being generated by the corresponding slave node based on the received master feedback result and received slave feedback results broadcast by other slave nodes; and the slave commit result being configured for representing whether the corresponding slave node agrees to execute the node freeze proposal, and representing whether a quantity of nodes agreeing to execute the node freeze proposal in the master node and the slave nodes is greater than the second quantity threshold; and
determine, based on the master commit result and the received slave commit results, that the consensus is reached on the node freeze proposal with the slave nodes.

In an embodiment, the processing module 82 is further configured to:
when a quantity of the received slave commit results is greater than a third quantity threshold, if the master commit result meets a first commit condition and a quantity of slave commit results meeting a second commit condition in the received slave commit results is greater than a fourth quantity threshold, determine that the consensus is reached on the node freeze proposal with the slave nodes,
the first commit condition being that the master node agrees and a quantity of nodes agreeing in the slave nodes is greater than the second quantity threshold; and the second commit condition being that the corresponding slave node agrees and the quantity of nodes agreeing in the master node and the slave nodes is greater than the second quantity threshold.

In an embodiment, the communication connection status includes a historical communication moment, where the historical communication moment is a moment with a smallest time difference from a current moment in moments at which the corresponding slave node communicates with the master node; and the status of the blockchain includes a slave node block height, where the slave node block height is a block height of the blockchain of the blockchain system recorded by corresponding slave node; and the processing module 82 is further configured to:
determine, according to the historical communication moment and the slave node block height, the to-be-frozen node meeting the freeze condition from the slave nodes, a time difference between the historical communication moment of the determined to-be-frozen node and the current moment being greater than a preset duration threshold, and a height difference between the slave node block height of the determined to-be-frozen node and a master node block height being greater than a preset height difference threshold; and the master node block height being a block height of a blockchain of the blockchain system recorded by the master node; and
create the node freeze transaction for the to-be-frozen node, and generate and broadcast the node freeze proposal based on the node freeze transaction.

In an embodiment, the slave node is associated with a freeze status, and the freeze status is frozen or unfrozen; and the processing module 82 is further configured to:
after the obtaining status information of each of the slave nodes, generate and broadcast a node unfreeze proposal when it is determined that a to-be-unfrozen node whose freeze status is frozen and whose status information meets an unfreeze condition exists in the slave nodes, the node unfreeze proposal being configured for representing a node unfreeze transaction of the to-be-unfrozen node; and the node unfreeze transaction being configured for indicating to perform data interaction with the to-be-unfrozen node when a blockchain of the blockchain system recorded by the corresponding slave node reaches an unfrozen block height; and
perform, based on the consensus algorithm in response to that a consensus is reached on the node unfreeze proposal with the slave nodes except the to-be-unfrozen node, data interaction with the slave nodes including the to-be-unfrozen node when the recorded blockchain of the blockchain system reaches the unfrozen block height.

Based on the same inventive concept, an embodiment of this disclosure provides a data processing apparatus, applied to slave nodes in a plurality of nodes included in a blockchain system. The plurality of nodes further include a master node associated with the slave nodes, so that functions corresponding to the foregoing data processing method can be achieved. Referring to FIG. 8B, the apparatus includes an obtaining module 801 and a processing module 802.

The obtaining module 801 is configured to receive a node freeze proposal broadcast by the master node, the node freeze proposal being generated when the master node determines that a to-be-frozen node whose status information meets a freeze condition exists in the slave nodes after the master node obtains status information of each of the slave nodes; the node freeze proposal being configured for representing a node freeze transaction of the to-be-frozen node; and the node freeze transaction being configured for indicating to restrict data interaction with the to-be-frozen node before a blockchain of the blockchain system recorded by the corresponding slave node reaches a frozen block height.

The processing module 802 is configured to, based on a consensus algorithm in response to that the master node reaches a consensus on the node freeze proposal with the slave nodes, data interaction with the master node and the slave nodes except the to-be-frozen node before the recorded blockchain of the blockchain system reaches the frozen block height.

In an embodiment, the master node and the slave nodes each are associated with a freeze status, and the freeze status is frozen or unfrozen; and the processing module 802 is further configured to:
before the performing data interaction with the master node and the slave nodes except the to-be-frozen node, obtain status information of the master node and the status information of each of the slave nodes;
when it is determined that a freeze status of the to-be-frozen node is unfrozen, if the status information of the to-be-frozen node meets the freeze condition, determine a target block height for restricting data interaction with the to-be-frozen node based on a preset freeze policy; and
determine, based on the obtained target block height, that the master node reaches the consensus on the node freeze proposal with the slave nodes.

In an embodiment, the processing module 802 is further configured to:
before the performing data interaction with the master node and the slave nodes except the to-be-frozen node, when it is determined that a freeze status of the to-be-frozen node is frozen, if the recorded blockchain of the blockchain system reaches a historical block height, determine a target block height for restricting data interaction with the to-be-frozen node based on a preset freeze policy, the historical block height being configured for representing a block height range that is indicated by a historical freeze proposal and that is for restricting data interaction with the to-be-frozen node; and the historical freeze proposal being a proposal generated for the to-be-frozen node before the node freeze proposal; and
determine, based on the obtained target block height, that the master node reaches the consensus on the node freeze proposal with the slave nodes.

In an embodiment, the processing module 802 is further configured to:
match the target block height with the frozen block height indicated by the node freeze transaction, and generate and broadcast a slave feedback result, the slave feedback result being configured for representing whether the corresponding slave node agrees to execute the node freeze proposal; and
receive a master feedback result broadcast by the master node, and receive slave feedback results broadcast by other slave nodes, the master feedback result being configured for representing that the master node agrees to execute the node freeze proposal; and
determine, based on the obtained master feedback result and slave feedback results, that the master node reaches the consensus on the node freeze proposal with the slave nodes.

In an embodiment, the processing module 802 is further configured to:
generate and broadcast a slave commit result based on the obtained master feedback result and slave feedback results when a quantity of the obtained master feedback result and slave feedback results is greater than a first quantity threshold, the slave commit result being configured for representing whether the corresponding slave node agrees to execute the node freeze proposal, and representing whether a quantity of nodes agreeing to execute the node freeze proposal in the master node and the other slave nodes is greater than a second quantity threshold;
receive a master commit result broadcast by the master node, and receive slave commit results broadcast by the other slave nodes, the master commit result being generated by the master node based on the received slave feedback results broadcast by the slave nodes; and the master commit result being configured for representing that the master node agrees to execute the node freeze proposal, and representing whether a quantity of nodes agreeing to execute the node freeze proposal in the slave nodes is greater than the second quantity threshold; and
determine, based on the obtained master commit result and slave commit results, that the master node reaches the consensus on the node freeze proposal with the slave nodes.

In an embodiment, the processing module 802 is further configured to:
when a quantity of the obtained master commit result and slave commit results is greater than a third quantity threshold, if the generated slave commit result meets a first commit condition and a quantity of commit results meeting a second commit condition in the received slave commit results and master commit result is greater than a fourth quantity threshold, determine that the master node reaches the consensus on the node freeze proposal with the slave nodes,
the first commit condition being that the corresponding slave node agrees and the quantity of nodes agreeing in the master node and the other slave nodes is greater than the second quantity threshold; and the second commit condition being that a corresponding master node or corresponding other slave nodes agree and the quantity of nodes agreeing in the master node and the other slave nodes is greater than the second quantity threshold.

In an embodiment, the processing module 802 is further configured to:
after the performing data interaction with the master node and the slave nodes except the to-be-frozen node, receive a node unfreeze proposal broadcast by the master node, the node unfreeze proposal being generated when the master node determines that a to-be-unfrozen node whose status information meets an unfreeze condition exists in the slave nodes after the master node obtains the status information of each of the slave nodes; the node unfreeze proposal being configured for representing a node unfreeze transaction of the to-be-unfrozen node; and the node unfreeze transaction being configured for indicating to perform data interaction with the to-be-unfrozen node when a blockchain of the blockchain system recorded by the corresponding slave node reaches an unfrozen block height; and
perform, based on the consensus algorithm in response to that the master node reaches a consensus on the node unfreeze proposal with other slave nodes except the to-be-unfrozen node, data interaction with the master node, the to-be-unfrozen node, and the other slave nodes when the recorded blockchain of the blockchain system reaches the unfrozen block height.

In an embodiment, the master node and the slave nodes each are associated with a freeze status, and the freeze status is frozen or unfrozen; and the processing module 802 is further configured to:
before the performing data interaction with the master node, the to-be-unfrozen node, and the other slave nodes, obtain the status information of the to-be-unfrozen node when it is determined that a freeze status of the to-be-unfrozen node is frozen; and determine, based on the consensus algorithm when it is determined that the status information of the to-be-unfrozen node meets the unfreeze condition, that the consensus is reached on the node unfreeze proposal with the master node and the other slave nodes except the to-be-unfrozen node; or
determine, based on the consensus algorithm when it is determined that a freeze status of the to-be-unfrozen node is unfrozen, that the consensus is reached on the node unfreeze proposal with the master node and the other slave nodes except the to-be-unfrozen node.

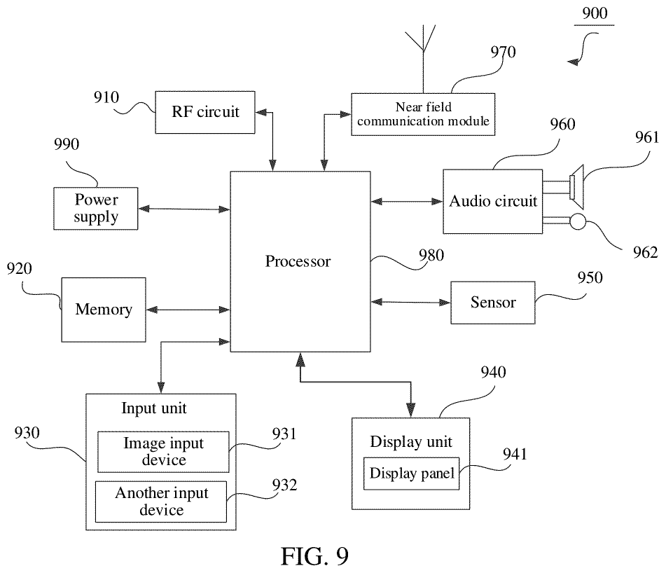

Referring to FIG. 9, the foregoing data processing apparatus may run on a computer device 900. A current version and a historical version of a data storage program and application software corresponding to the data storage program may be installed on the computer device 900. The computer device 900 includes a processor 980 and a memory 920. In some embodiments, the computer device 900 may include a display unit 940. The display unit 940 includes a display panel 941, configured to display an operation interface for user interaction and the like.

In an embodiment, the display panel 941 may be configured in a form of a liquid crystal display (LCD), an organic light-emitting diode (OLED), or the like.

The processor 980 is configured to read a computer program and then perform a method defined by the computer program. For example, the processor 980 reads the data storage program or a file, to run the data storage program on the computer device 900, and display a corresponding interface on the display unit 940. The processor 980 may include one or more general-purpose processors, and may further include one or more digital signal processors (DSP), configured to perform related operations, to implement the technical solutions provided in the embodiments of this disclosure.

The memory 920 generally includes an internal memory and an external memory. The internal memory may be a random access memory (RAM), a read-only memory (ROM), a cache (CACHE), or the like. The external memory may be a hard disk, an optical disc, a USB disk, a floppy disk, a tape drive, or the like. The memory 920 is configured to store a computer program and other data. The computer program includes an application program corresponding to each client. The other data may include data generated after an operating system or an application program is run, where the data includes system data (for example, configuration parameters of the operating system) and user data. In this embodiment of this disclosure, the memory 920 has program instructions stored therein, and the processor 980 executes the program instructions in the memory 920, to implement any method described in the foregoing descriptions and figures.

The display unit 940 is configured to receive inputted digit information, character information, or contact touch operation/non-contact gesture, and generate a signal input related to a user setting and function control of the computer device 900. Specifically, in this embodiment of this disclosure, the display unit 940 may include a display panel 941. The display panel 941, for example, a touchscreen, may collect a touch operation that is performed by a user on or near the display panel 941 (for example, an operation that is performed by a user by using any appropriate object or accessory such as a finger or a stylus on or near the display panel 941), and drive a corresponding connection apparatus according to a preset program.

In an embodiment, the display panel 941 may include two parts: a touch detection apparatus and a touch controller. The touch detection apparatus detects a touch orientation of the player, detects a signal brought through the touch operation, and transmits the signal to the touch controller. The touch controller receives touch information from the touch detection apparatus, converts the touch information into a contact coordinate, then transmits the contact coordinate to the processor 980, and receives and executes a command transmitted by the processor 980.

In addition, the display panel 941 may be implemented in a plurality of types, such as a resistive type, a capacitive type, an infrared type, and a surface acoustic wave type. In addition to the display unit 940, in some embodiments, the computer device 900 may further include an input unit 930. The input unit 930 may include an image input device 931 and another input device 932. The another input device may include, but not limited to, one or more of a physical keyboard, a functional key (such as a volume control key or a switch key), a track ball, a mouse, and a joystick.

In addition to the above, the computer device 900 may further include a power supply 990 configured to supply power to other modules, an audio circuit 960, a near field communication module 970, and a radio frequency (RF) circuit 910. The computer device 900 may further include one or more sensors 950, for example, an acceleration sensor, an optical sensor, and a pressure sensor. The audio circuit 960 specifically includes a speaker 961, a microphone 962, and the like. For example, the computer device 900 may collect a sound of the user by using the microphone 962, perform a corresponding operation, and the like.

In an embodiment, there may be one or more processors 980, and the processor 980 and the memory 920 may be coupled, or may be arranged independently.

In an embodiment, the processor 980 in FIG. 9 may be configured to implement the functions of the obtaining module 81 and the processing module 82 in FIG. 8A, and may be further configured to implement the functions of the obtaining module 801 and the processing module 802 in FIG. 8B.

In an embodiment, the processor 980 in FIG. 9 may be configured to implement the functions corresponding to the server or terminal device described in the foregoing descriptions.

A person of ordinary skill in the art may understand that, all or some of steps of the foregoing method embodiments may be implemented by a program instructing relevant hardware. The program may be stored in a computer-readable storage medium. During execution of the program, the steps of the foregoing method embodiments are performed. The foregoing storage medium includes any medium that can store program code, such as a USB, a ROM, a RAM, a magnetic disk, or an optical disc.

Alternatively, when the integrated unit in the present disclosure is implemented in the form of a software functional module and sold or used as an independent product, the integrated unit may be stored in a computer-readable storage medium. Based on such an understanding, the technical solutions of the embodiments of the present disclosure essentially, or the part contributing to the prior art, may be implemented in the form of a software product, for example, may be implemented in a computer program product. The computer program product is stored in a storage medium, and includes several instructions for instructing a computer device to perform all or a part of the steps of the method described in the embodiments of the present disclosure. The foregoing storage medium includes any medium that can store program code, such as a USB, a ROM, a RAM, a magnetic disk, or an optical disc.

Certainly, a person skilled in the art can make various modifications and variations to this disclosure without departing from the spirit and scope of this disclosure. In this case, if the modifications and variations made to this disclosure fall within the scope of the claims of this disclosure and their equivalent technologies, this disclosure is intended to include these modifications and variations.

What is claimed is:

1. A data processing method, applied to a master node in a plurality of nodes comprised in a blockchain system, the plurality of nodes further comprising a plurality of slave nodes associated with the master node, and the data processing method comprising:
obtaining status information of each of the slave nodes, the status information comprising a communication connection status of the corresponding slave node and a status of a blockchain recorded by the slave node in the blockchain system;
in response to the status information of a first slave node among the slave nodes meeting a freeze condition, generating and broadcasting a node freeze proposal,
the node freeze proposal being for representing a node freeze transaction of the first slave node, and the node freeze transaction indicating to restrict data interaction of the first slave node with other nodes before blockchains recorded by the other nodes reach a frozen block height; and
in response to the master node reaching a consensus on the node freeze proposal with the slave nodes based on a consensus algorithm, performing data interaction with the slave nodes other than the first slave node before the recorded blockchains reach the frozen block height.

2. The method according to claim 1, wherein the method further comprises:
generating a master feedback result for the node freeze proposal, and broadcasting the master feedback result to the slave nodes, the master feedback result being for representing that the master node agrees to execute the node freeze proposal;
receiving slave feedback results broadcast by the slave nodes, the slave feedback result being for representing whether the corresponding slave node agrees to execute the node freeze proposal; and
determining, based on the master feedback result and the received slave feedback results, that the consensus is reached on the node freeze proposal with the slave nodes.

3. The method according to claim 2, wherein the determining, based on the master feedback result and the received slave feedback results, that the consensus is reached on the node freeze proposal with the slave nodes comprises:
generating and broadcasting a master commit result based on the master feedback result and the received slave feedback results when a quantity of the received slave feedback results is greater than a first quantity threshold,
the master commit result being for representing that the master node agrees to execute the node freeze proposal, and representing whether a quantity of nodes agreeing to execute the node freeze proposal in the slave nodes is greater than a second quantity threshold;
receiving slave commit results respectively broadcast by the slave nodes, the slave commit result being generated by the corresponding slave node based on the received master feedback result and received slave feedback results broadcast by other slave nodes,
the slave commit result being for representing whether the corresponding slave node agrees to execute the node freeze proposal, and representing whether a quantity of nodes agreeing to execute the node freeze proposal in the master node and the slave nodes is greater than the second quantity threshold; and
determining, based on the master commit result and the received slave commit results, that the consensus is reached on the node freeze proposal with the slave nodes.

4. The method according to claim 3, wherein the determining, based on the master commit result and the received slave commit results, that the consensus is reached on the node freeze proposal with the slave nodes comprises:
in response to a quantity of the received slave commit results being greater than a third quantity threshold, the master commit result meeting a first commit condition, and a quantity of slave commit results meeting a second commit condition in the received slave commit results being greater than a fourth quantity threshold, determining that the consensus is reached on the node freeze proposal with the slave nodes,
the first commit condition being that the master node agrees and a quantity of nodes agreeing in the slave nodes is greater than the second quantity threshold, and
the second commit condition being that the corresponding slave node agrees and the quantity of nodes agreeing in the master node and the slave nodes is greater than the second quantity threshold.

5. The method according to claims 1, wherein the communication connection status comprises a historical communication moment, wherein the historical communication moment is a moment with a smallest time difference from a current moment among moments at which the corresponding slave node communicates with the master node; and the status of the blockchain comprises a slave node block height, the slave node block height is a block height of the blockchain recorded by the corresponding slave node;
the generating and broadcasting a node freeze proposal comprises:
identifying, according to the historical communication moment and the slave node block height, the first slave node meeting the freeze condition from the slave nodes,
a time difference between the historical communication moment of the first slave node and the current moment being greater than a preset duration threshold, and
a height difference between the slave node block height of the first slave node and a master node block height being greater than a preset height difference threshold, the master node block height being a block height of a blockchain recorded by the master node; and
creating the node freeze transaction for the first slave node, and
generating and broadcasting the node freeze proposal based on the node freeze transaction.

6. The method according to claim 1, wherein a slave node is associated with a freeze status, and the freeze status is frozen or unfrozen, the method further comprises:
in response to the freeze status of a second slave node being frozen and the status information of the second slave node meeting an unfreeze condition, generating and broadcasting a node unfreeze proposal, the node unfreeze proposal being for representing a node unfreeze transaction of the second slave node, and the node unfreeze transaction being indicating to allow data interaction of the second slave with other nodes when blockchains recorded by the other nodes reach an unfrozen block height; and
in response to a consensus being reached on the node unfreeze proposal with the slave nodes other than the second slave node based on the consensus algorithm, performing data interaction with the slave nodes including the second slave node when the recorded blockchains reach the unfrozen block height.

7. A data processing method, applied to slave nodes in a plurality of nodes comprised in a blockchain system, the plurality of nodes further comprising a master node associated with the slave nodes, and the data processing method comprising:
receiving a node freeze proposal broadcast by the master node, the node freeze proposal being generated when the master node determines that a first slave node whose status information meets a freeze condition exists in the slave nodes,
the node freeze proposal being for representing a node freeze transaction of the first slave node, and the node freeze transaction being indicating to restrict data interaction with the first slave node before blockchains recorded by other slave nodes reach a frozen block height; and
in response to a consensus being reached on the node freeze proposal among the master node and the slave nodes based on a consensus algorithm, performing data interaction with the master node and the slave nodes other than the first slave node before the recorded blockchains reach the frozen block height.

8. The method according to claim 7, wherein the master node and the slave nodes each are associated with a freeze status, and the freeze status is frozen or unfrozen, and the method further comprises:
obtaining status information of the master node and the status information of each of the slave nodes;
in response to a freeze status of the first slave node being unfrozen and the status information of the first slave node meeting the freeze condition, determining a target block height for restricting data interaction with the first slave node based on a preset freeze policy; and
determining, based on the target block height, that the master node reaches the consensus on the node freeze proposal with the slave nodes.

9. The method according to claim 7, wherein the method further comprises:
in response to a freeze status of the first slave node being frozen and the recorded blockchains reach a historical block height, determining a target block height for restricting data interaction with the first slave node based on a preset freeze policy,
the historical block height being for representing a block height range that is indicated by a historical freeze proposal, and the historical freeze proposal being a proposal generated for the first slave node before the node freeze proposal; and
determining, based on the target block height, that the master node reaches the consensus on the node freeze proposal with the slave nodes.

10. The method according to claim 9, wherein the determining that the master node reaches the consensus on the node freeze proposal with the slave nodes comprises:
matching the target block height with the frozen block height indicated by the node freeze transaction, and generating and broadcasting a slave feedback result, the slave feedback result being for representing whether the corresponding slave node agrees to execute the node freeze proposal;
receiving a master feedback result broadcast by the master node, and receiving slave feedback results broadcast by other slave nodes, the master feedback result being for representing that the master node agrees to execute the node freeze proposal; and
determining, based on the master feedback result and slave feedback results, that the master node reaches the consensus on the node freeze proposal with the slave nodes.

11. The method according to claim 10, wherein the determining that the master node reaches the consensus on the node freeze proposal with the slave nodes comprises:
generating and broadcasting a slave commit result based on the master feedback result and slave feedback results when a quantity of the master feedback result and slave feedback results is greater than a first quantity threshold,
the slave commit result being for representing whether the corresponding slave node agrees to execute the node freeze proposal, and representing whether a quantity of nodes agreeing to execute the node freeze proposal in the master node and the other slave nodes is greater than a second quantity threshold;
receiving a master commit result broadcast by the master node, and receiving slave commit results broadcast by the other slave nodes,
the master commit result being generated by the master node based on the received slave feedback results broadcast by the slave nodes, and the master commit result being for representing that the master node agrees to execute the node freeze proposal, and representing whether a quantity of nodes agreeing to execute the node freeze proposal in the slave nodes is greater than the second quantity threshold; and
determining, based on the master commit result and slave commit results, that the master node reaches the consensus on the node freeze proposal with the slave nodes.

12. The method according to claim 11, wherein the determining that the master node reaches the consensus on the node freeze proposal with the slave nodes comprises:
in response to a quantity of the master commit result and slave commit results being greater than a third quantity threshold, the generated slave commit result meeting a first commit condition, and a quantity of commit results meeting a second commit condition in the received slave commit results and master commit result is greater than a fourth quantity threshold, determining that the master node reaches the consensus on the node freeze proposal with the slave nodes,
the first commit condition being that the corresponding slave node agrees and the quantity of nodes agreeing in the master node and the other slave nodes is greater than the second quantity threshold; and
the second commit condition being that the master node or the other slave nodes agree and the quantity of nodes agreeing in the master node and the other slave nodes is greater than the second quantity threshold.

13. The method according to claim 7, wherein the method further comprises:
receiving a node unfreeze proposal broadcast by the master node, the node unfreeze proposal being generated when the master node determines that a second slave node whose status information meets an unfreeze condition exists in the slave nodes,
the node unfreeze proposal being for representing a node unfreeze transaction of the second slave node, and the node unfreeze transaction indicating to allow data interaction of the second slave node with other nodes when blockchains recorded by the other nodes reach an unfrozen block height; and
in response to the master node reaching a consensus on the node unfreeze proposal with other slave nodes other than the second slave node based on the consensus algorithm, performing data interaction with the master node, the second slave node, and the other slave nodes when the recorded blockchains reach the unfrozen block height.

14. The method according to claim 13, wherein the master node and the slave nodes each are associated with a freeze status, and the freeze status is frozen or unfrozen, the method further comprises:
in response to a freeze status of the second slave node being frozen, obtaining the status information of the second slave node; and
in response to the status information of the second slave node meeting the unfreeze condition, determining, based on the consensus algorithm, that the consensus is reached on the node unfreeze proposal with the master node and the other slave nodes other than the second slave node.

15. The method according to claim 13, wherein the master node and the slave nodes each are associated with a freeze status, and the freeze status is frozen or unfrozen, the method further comprises:
in response to a freeze status of the second slave node being unfrozen, determining, based on the consensus algorithm, that the consensus is reached on the node unfreeze proposal with the master node and the slave nodes other than the second slave node.

16. A data processing apparatus, applied to a master node in a plurality of nodes comprised in a blockchain system, the plurality of nodes further comprising a plurality of slave nodes associated with the master node, and the data processing apparatus comprising:
a memory operable to store computer-readable instructions; and
a processor circuitry operable to read the computer-readable instructions, the processor circuitry when executing the computer-readable instructions is configured to:
obtain status information of each of the slave nodes, the status information comprising a communication connection status of the corresponding slave node and a status of a blockchain recorded by the slave node in the blockchain system;
in response to the status information of a first slave node among the slave nodes meeting a freeze condition, generate and broadcast a node freeze proposal,
the node freeze proposal being for representing a node freeze transaction of the first slave node, and the node freeze transaction indicating to restrict data interaction of the first slave node with other nodes before blockchains recorded by the other nodes reach a frozen block height; and
in response to the master node reaching a consensus on the node freeze proposal with the slave nodes based on a consensus algorithm, perform data interaction with the slave nodes other than the first slave node before the recorded blockchains reach the frozen block height.

17. The apparatus according to claim 16, wherein the processor circuitry is further configured to:
generate a master feedback result for the node freeze proposal, and broadcast the master feedback result to the slave nodes, the master feedback result being for representing that the master node agrees to execute the node freeze proposal;
receive slave feedback results broadcast by the slave nodes, the slave feedback result being for representing whether the corresponding slave node agrees to execute the node freeze proposal; and
determine, based on the master feedback result and the received slave feedback results, that the consensus is reached on the node freeze proposal with the slave nodes.

18. The apparatus according to claim 17, wherein the processor circuitry is configured to:
generate and broadcast a master commit result based on the master feedback result and the received slave feedback results when a quantity of the received slave feedback results is greater than a first quantity threshold,
the master commit result being for representing that the master node agrees to execute the node freeze proposal, and representing whether a quantity of nodes agreeing to execute the node freeze proposal in the slave nodes is greater than a second quantity threshold;
receive slave commit results respectively broadcast by the slave nodes, the slave commit result being generated by the corresponding slave node based on the received master feedback result and received slave feedback results broadcast by other slave nodes,
the slave commit result being for representing whether the corresponding slave node agrees to execute the node freeze proposal, and representing whether a quantity of nodes agreeing to execute the node freeze proposal in the master node and the slave nodes is greater than the second quantity threshold; and
determine, based on the master commit result and the received slave commit results, that the consensus is reached on the node freeze proposal with the slave nodes.

19. The apparatus according to claim 18, wherein the processor circuitry is configured to:
in response to a quantity of the received slave commit results being greater than a third quantity threshold, the master commit result meeting a first commit condition, and a quantity of slave commit results meeting a second commit condition in the received slave commit results being greater than a fourth quantity threshold, determine that the consensus is reached on the node freeze proposal with the slave nodes,
the first commit condition being that the master node agrees and a quantity of nodes agreeing in the slave nodes is greater than the second quantity threshold, and
the second commit condition being that the corresponding slave node agrees and the quantity of nodes agreeing in the master node and the slave nodes is greater than the second quantity threshold.

20. The apparatus according to claims 16, wherein the communication connection status comprises a historical communication moment, wherein the historical communication moment is a moment with a smallest time difference from a current moment among moments at which the corresponding slave node communicates with the master node; and the status of the blockchain comprises a slave node block height, the slave node block height is a block height of the blockchain recorded by the corresponding slave node, the processor circuitry is configured to:
identify, according to the historical communication moment and the slave node block height, the first slave node meeting the freeze condition from the slave nodes,
a time difference between the historical communication moment of the first slave node and the current moment being greater than a preset duration threshold, and
a height difference between the slave node block height of the first slave node and a master node block height being greater than a preset height difference threshold, the master node block height being a block height of a blockchain recorded by the master node; and
creating the node freeze transaction for the first slave node, and
generate and broadcast the node freeze proposal based on the node freeze transaction.
